(19) United States
(12) Patent Application Publication
(10) Pub. No.: US 2003/0009367 A1
(43) Pub. Date: Jan. 9, 2003

(54) Process for consumer-directed prescription influence and health care product marketing

(76) Inventor: Royce Morrison, Seattle, WA (US)

Correspondence Address: Bernhard D. Saxe, FOLEY & LARDNER, Washington Harbour, 3000 K Street, N.W., Suite 500, Washington, DC, 20007-5109, US

(21) Appl. No.: 09/899,526

(22) Filed: Jul. 6, 2001

(51) Int. Cl. G06F 17/60

(52) U.S. Cl. 705/9

(57) ABSTRACT

A method employing a computer system for marketing a health care product includes receiving information about characteristics of at least one of a consumer and a decision influencer. Based on the received information, the method retrieves stored information from a database accessible by the computer system. The stored information contains at least one of consumer information, decision influencer information, and product information. The method then analyzes the received information and the stored information to determine the presence of a sufficient indication of at least one of (i) consumer interest in the health care product and (ii) product-related relationships between the consumer and decision influencers identifiable from the stored decision influencer information. If sufficient indication is present, the method retrieves a list of potential actions related to the health care product from a product information database. The method then evaluates whether to perform each of the potential actions based on at least one of the consumer information, the decision influencer information, the product information, and action-specific criteria. The method performs potential actions that meet action-specific criteria.

### BACKGROUND OF THE INVENTION

1. Technical Field of the Invention

The present invention provides a process and an apparatus for (1) facilitating consumer and professional interaction and communication about products and services that require a professional decision before a consumer can purchase or be prescribed a particular product or service by a professional, (2) facilitating the marketing of regulated products by manufacturers to professionals, consumers and health care systems, and (3) providing consumers with a means for influencing decisions of professions and health care systems with respect to providing a product or service and having the product or service available with a particular health care system program.

2. Health Care Products Markets

Health care products markets are characterized by the legal and/or contractual assignment to health care professionals and/or health care systems of the authority to prescribe, specify, authorize, cover (bear the cost of), restrict, prohibit, or exclude products for use by consumers. For example, a consumer may not independently decide to purchase and use a prescription product; the prerogative to approve or deny access to the product belongs to professionals with prescriptive authority. Further, the availability and/or benefit “coverage” of a particular product within a particular health care system (e.g., Blue Cross of Pennsylvania or Harvard Community Health Plan) may be subject to approval by a Pharmacy and Therapeutics Committee, Formulary Committee, an official of a Pharmacy Benefit Management company, Surgical Care Pathways Committee, Alternative Medicine Committee, etc. Therefore, the consumer's use of or ability to afford a particular product depends upon the decisions and judgements of professionals and others in those health care systems.

In the relationship between individual consumer and health care professional, the decision to use a product is shared. The professional must approve and prescribe the product or service and the consumer must agree to use it. However, the decision-making process has typically been highly asymmetrical, with the preponderance of information (about the medical condition under treatment and the product or service proposed for use) and initiative being in the sole possession of the professional. The hurried process of the medical consultation often does not allow extensive or even adequate transfer of information, and the consumer's ability to participate in the decision-making process is limited.

Even so, the dynamics of the relationship are undergoing change, with shifts in cultural attitudes about health care relationships and with the advent of information and communications systems which enable consumers to search for and find health care and health product information. Further, the rapid increase in pharmaceutical manufacturers' direct-to-consumer (DTC) marketing activities has heightened consumers' awareness of diagnoses and treatments, particularly newly marketed treatments. Consumers increasingly gain access to information about medical diagnosis and about products even before such information has been received or integrated into practice protocols by individual health care professionals or health care systems.

However, in existing health care system relationships, the consumer's ability to accelerate the consideration of a product and to influence product decisions remains limited by lack of information, by barriers of time and effort, and by a lack of mechanisms for initiating action. In the relationship between individual consumer and professional, the interested, assertive consumer may attempt, before making an appointment, to determine whether the professional is knowledgeable about the product of interest, but the communication and response processes of typical professional offices do not provide confident, satisfactory answers to that question. The consumer may make an appointment to consult with the professional about a health problem and the possible use of a particular product, but information about the reason for the appointment is not evident to the professional until the scheduled visit, allowing no time for the professional to prepare. If the consumer has brought printed information to the visit, the hurried setting does not permit the professional time to review, consider, integrate, and use the information, and the professional (as a highly trained individual) may feel that the consumer-provided information is not adequate for the purpose. The professional, unprepared to discuss the product, may feel embarrassed and/or negatively biased against it. The consumer may feel that his or her request was overly assertive and that the relationship is strained. At best, the professional may agree to make the effort to investigate the topic, and the consumer must return for another consultation. The consumer largely loses the time, effort, and financial cost of the consultation. Therefore, there is a need to improve this relationship when the consumer has taken steps to research treatments for his or her health status.

The consumer may find that the particular health care system or insurer has not yet considered the product for inclusion in its restricted formulary, or has considered and rejected it for reasons that are unavailable, unexplained or unconvincing to the consumer. The individual consumer's expression of preference has little or no impact on decision-makers at a particular health care system or insurer. Consumers in the same health care system with similar concerns are unable, without inordinate effort and expense (such as bulk mailings, published notices, or redirection of a meeting agenda), to identify each other and are consequently unable to form an interest group to aggregate and exert their pooled influence.

Therefore, in the existing health products market system, (1) a consumer may become interested in the possible use of a product, and not be able to anticipate the particular information needs of the health care professional; or (2) prefer that the manufacturer and/or other sources of information provide information and information choices to the health care professional in anticipation of consultation; or (3) wish to identify and gain access to health professionals who are already informed about and prepared to discuss and consider the possible use of the product; or (4) wish to express preferences regarding products, to aggregate, report and be aware of the preferences of other consumers, to participate in a related interest group's activities, and to increase the influence of consumers' preferences on product decisions in the consumer's health care system.

At present, there are inadequate means for consumers to effect any of the four foregoing activities. Thus, there is a need in the art to devise a process to facilitate the foregoing four activities.

The implications of the above four activities can be further developed as follows:

(1) The consumer may not be able to anticipate the particular information needs of the health care professional.

The professional may already be well informed and need only information about what has changed in light of recently reported clinical experience. The professional may have partial recall of information about the product and need to review or update information. The professional may be uninformed about the product (particularly if it is new or used for rarely encountered disease states) and need to learn about it and to review the pathophysiology of the disease states for which the product might be appropriately prescribed. The professional may need to present new information about the product to a formulary committee, to seek its admission to the health care system's pharmacy formulary. In any case, the consumer has limited ability to assess or anticipate the professional's information needs.

At present, the health care products market system does not conveniently provide information and service resources from manufacturers or other information sources for selection by a health care professional responding to a consumer's interest in a specific product. There is a need in the art to do so.

(2) The consumer may prefer that the manufacturer or other information provider inform and suggest further information and service choices to the health care professional, in anticipation of consultation between the consumer and the professional.

A consumer may feel that his or her efforts to gather and present information to the professional will be less effective than the professional's own choices of information from conveniently available resources. A consumer may feel uncomfortable providing information directly or being identified to the professional. Accordingly, a consumer may prefer to direct the manufacturer or other information providers to inform the professional that a consumer is interested in the product and to offer more product-related information to the professional. Prompted by notice of a consumer's interest in a product, a professional may then choose to draw on the services provided by the manufacturer or other information provider, or seek information elsewhere. The professional can then be prepared for discussion and shared decision-making with the consumer. In any case, the knowledge that a consumer is interested in the product and will soon be consulting about it will help the professional in making best use of time and effort expended for continuing education. The use of available information resources and the need to apply them in professional practice can occur in quick succession, positively reinforcing learning, easing stress for the professional, increasing satisfaction for the consumer, and improving the effectiveness of marketing efforts for the manufacturer.

At present, shared-decision market systems do not conveniently facilitate such requests by consumers for informational marketing by manufacturers or provision of information by other sources to individual health care professionals. There is a need in the art to do so.

(3) The consumer may wish to identify and gain access to health professionals who are already informed about and prepared to discuss and consider the possible use of the product.

For example, a consumer interested in a new drug product may not have a relationship with a primary or specialty physician and may wish to identify a physician who is already informed about the new drug product. While knowledge of a physician's specialty increases the likelihood of identifying a physician who is prepared to consult about the particular product, it is not entirely reliable, particularly in the case of a new product and less than fully effective marketing efforts of manufacturers. Further, while it is possible for consumers to telephone professionals' offices to inquire about knowledge of a particular product, a professional's office staff are more likely to give nonspecific assurances than to interrupt the professional's work to pose the specific question. While the manufacturer of a new pharmaceutical product may be motivated to provide information about physicians who have been informed about the product or service, convenient, Internet-mediated systems for responding to consumer requests for such information do not exist with manufacturers of pharmaceutical products and could open up regulatory scrutiny if offered by manufacturers. There is a need in the art to conveniently provide this information to consumers.

(4) The consumer may wish to express preferences regarding products or services, to aggregate, report and be aware of the preferences of other consumers, to participate in a related interest group's activities, and to increase the influence of consumer preferences on product decisions in the consumer's health care system or insurer.

Individual consumers may become interested in a product, but they do not know how many other consumers in the same health care system or insurance plan share a similar interest in that product, and they have no convenient way of communicating aggregated information about preferences to physicians, administrators, and committees. This makes it difficult for consumers, as a class, to influence the decisions of health care systems and insurers regarding pharmacy formulary and other product decisions.

At present, health care product market systems do not conveniently facilitate such expression, aggregation, and reporting of preferences by consumers, nor the mutual identification of consumers for interest group activity. There is a need in the art to do so.

Regulatory Constraints on Provision of Information by Manufacturers

A further limitation of the existing health care prescription drug market is that, while manufacturers are motivated to provide comprehensive information to health care professionals and professionals are trained to assess such information, regulatory constraints applied by the U.S. Food and Drug Administration (FDA) preclude provision of certain categories of information about prescription products. Specifically, though uses of drugs for which the FDA has not granted official approval are legally and ethically employed by professionals and consumers, manufacturers are not allowed to provide information about such uses to professionals, with minor exceptions. This makes it more difficult for consumers and professionals to obtain such information and makes it impossible for manufacturers to respond to a consumer's request or a professional's request to provide complete information from the medical literature. There is a need in the art to allow the dissemination of information to professionals, trained to evaluate such information, but still within regulatory guidelines and while avoiding regulatory noncompliance by manufacturers.

In addition, the FDA is a regulatory agency that functions to approve (or deny) marketing of products (drugs or devices) according to a complex regulatory scheme set forth in 21 C.F.R. In general, the manufacturer submits an appropriate product application (such as a New Drug Application or NDA for a drug, or a premarket application or pma for a device) and the FDA only communicates with the manufacturer. The result of product marketing approval is that the indications and label copy of approved products are negotiated between the FDA and the manufacturer. The FDA then regulates the manufacturer to comply with approved market parameters and monitors submission of adverse incidents reports that are submitted by the manufacturers or sometimes by professionals. The consumers do not have a voice in this process of either product approval or the extent of approved uses for an approved product. There is a need to provide a means for the consumer to have a greater voice and influence in this regulatory process as it is designed to be in the consumers' benefit.

Similarly, Health and Human Services (HHS) at the Federal level and insurance commissioners on a State level are empowered to regulate Federal heath care systems, such as Medicare and Medicaid, and state health care systems, such as HMOs, in regulating those products and services that can and cannot be in a formulary or subject to reimbursement. Again, the consumer does not have a voice or at least a significant voice in influencing such regulatory directives. Again, there is a need to provide a means for the consumer to have a greater voice and influence in this regulatory process as it directly impacts the consumers' benefits.

Networked Information Systems

Networked personal computer systems are revolutionizing processes of information, communication, and commercial transactions. While these changes have been developing for three decades or more, they are rapidly advancing due to the recent advent of unrestricted public access to the Internet, combined with the availability of inexpensive and powerful personal computer systems with highly functional software systems supporting easy use of the Internet's increasingly valuable resources. While the present invention's uses are applicable to any networked information system to which consumers have ready access, the dominant system for practical purposes is the Internet.

The Internet is an electronic communications system based on standards and protocols which are widely accepted and allow users with a variety of computer hardware and software systems to gain access to worldwide information and communications resources. Millions of commercial, governmental, and noncommercial entities have created Internet websites offering information and communication opportunities to users. Pharmaceutical companies, for example, create product-specific websites for virtually every new pharmaceutical product and widely advertise the availability of those websites without access restrictions. Users may connect with websites by entry of-specific Internet website addresses. In the case of unknown address or unknown resources, Internet search engine services allow users to find information about almost any topic of interest. Health-related Internet information resources have high rates of use by consumers and professionals.

Therefore, there is a need in the art to utilize the efficiencies created by the Internet to meet the foregoing needs of consumers, professionals and manufacturers regarding the dissemination of product information within the boundaries of regulatory compliance. The present invention addresses the foregoing needs.

### SUMMARY OF THE INVENTION

One embodiment of the invention relates to a method for employing a computer system for marketing a health care product. The method includes receiving information about characteristics of at least one of a consumer and a decision influencer. Based on the received information, the method retrieves stored information from a database accessible by the computer system. The stored information contains at least one of consumer information, decision influencer information, and product information. The method then analyzes the received information and the stored information to determine the presence of a sufficient indication of at least one of (i) consumer interest in the health care product and (ii) product-related relationships between the consumer and decision influencers identifiable from the stored decision influencer information. If sufficient indication is present, the method retrieves a list of potential actions related to the health care product from a product information database. The method then evaluates whether to perform each of the potential actions based on at least one of the consumer information, the decision influencer information, the product information, and action-specific criteria. The method then performs the potential actions that meet the action-specific criteria.

The method can include the additional steps of, prior to the performing step, prioritizing and/or sequencing and/or grouping the potential actions that meet the action-specific criteria.

In another aspect of the invention, a computer-implemented method for facilitating marketing of a health care product includes receiving input from at least one of a consumer and a system agent that identifies consumer interest in the health care product and that contains consumer identity information; based on the input, identifying a decision influencer that has a product-related relationship with the consumer; and, absent explicit instruction from the consumer, communicating information about at least one of the consumer interest, the product-related relationship, and the health care product to the identified decision influencer. The identifying step can be accomplished by identifying the decision influencer from a plurality of decision influencers stored in a database.

A computer system to facilitate marketing of a health care product comprises an interface device for receiving information about characteristics of at least one of a consumer and a decision influencer; and a system controller having access to a first data medium that stores data about a plurality of decision influencers and a second data medium that stores data about the health care product, wherein, based on the characteristics information and the stored data, the system controller identifies decision influencers that have a product-related relationship with the consumer and communicates information to the identified decision influencers about at least one of the health care product, consumer interest in the health care product, presence of the product-related relationship with the consumer, and a request by the consumer that the information be communicated.

### BRIEF DESCRIPTION OF THE DRAWINGS

FIG. 1 illustrates a hardware configuration for a Consumer-Directed Prescription Influence Service and Information System (CDPI system).

FIG. 2 shows a Consumer's or System Agent's Interface Device in a block diagram format.

FIG. 3 shows a Decision Influencer's or System Agent's Interface Device in a block diagram format.

FIG. 4 illustrates a CDPI System Controller in a block diagram format showing an embodiment of the computer controller of the consumer-directed prescription influence service and information system.

FIG. 5 shows a CDPI Internet Interface process, illustrating an embodiment having the logical and event sequencing of an interactive session of a consumer and the CDPI system.

FIG. 6 shows a Consumer-Directed “Inform Doctor” Transaction process, illustrating how a consumer interacts with the CDPI system to direct provision of product information and consumer-specific information to a designated professional (e.g., doctor).

FIG. 7 shows a Consumer-Directed “Report Informed Doctors” Transaction process, showing how a consumer interacts with the CDPI system to direct reporting of product-informed doctors who meet the consumer's selection criteria.

FIG. 8 shows a Consumer-Directed “Express Preference” Transaction process, showing how a consumer interacts with the CDPI system to direct expression of product- and disease state-related consumer preferences, how a consumer directs communication of those preferences, and how a consumer directs the CDPI system's subsequent routing of related messages to the professional or health care system.

FIG. 9 shows a CDPI System process with consumer ID and message functions, showing how a consumer interacts with the CDPI system to direct provision of the consumer's identification information, and/or the consumer's message, to designated recipients.

FIG. 10 shows a CDPI System process with a consumer receive function, wherein a consumer chooses to receive subsequent topical messages through the CDPI system, showing how a consumer interacts with the CDPI system to direct forwarding of messages to the consumer at an address specified by the consumer.

FIG. 11 shows a reference database query process, wherein the CDPI Central Controller queries external reference database systems with or without the involvement of human-to-computer interfaces.

FIG. 12 shows a CDPI Consumer or System Agent Internet Interface process in accordance with an embodiment of the invention.

FIG. 13 shows an action outcome analysis and CDPI system modification process.

FIG. 14 shows a CDPI process with a consumer or decision influencer opt-in function.

FIG. 15 shows a CDPI process with a function to determine the explicit or implicit presence of certain consumer characteristics.

### DETAILED DESCRIPTION OF THE PREFERRED EMBODIMENTS

As will be made clear below, the general availability of personal computers and of the Internet and the advent of the present invention make possible mechanisms to enable and encourage influential consumer-directed transactions of the kinds described above and to increase the efficiencies of health care professionals' education activities and of manufacturers' marketing activities.

Definitions

Health Care Product includes prescription-based therapeutic agents, medical devices, and services (e.g., physical therapy, surgical placement of appliances, etc.), and nonprescription diagnostic and therapeutic agents, devices, and services.

Consumer includes individual consumers or potential consumers of health care products and services, the responsible guardians of minors or of legally incompetent individuals, the owners of animals receiving or potentially receiving veterinary care, and groups of individual consumers or potential consumers of health care products.

Decision influencers are parties who are related or potentially related to a consumer because they have some legal, contractual, administrative, political, financial, representational, judicial, or consultative influence on the availability, affordability, or practical usability of health care products for the consumer. Such decision influencers include, without limitation, individuals and groups of individuals, professionals, health care systems, other consumers, manufacturers, governmental executive agents (e.g., governmental regulators and governmental administrators), governmental legislators, governmental judiciary agents, organizations, and companies.

Professional includes all health care professionals who have prescriptive authority (such as physicians, nurse practitioners, physicians' assistants, dentists, and veterinarians) or have influence (such as nurses, therapists, pharmacists, and chiropractors) in the choice and prescription of products.

System Agent includes any party interacting on behalf of the CDPI system with consumers or decision influencers, including, for example, prompting interaction, receiving information, transmitting information to CDPI system, receiving reports or instructions from CDPI system, initiating Actions on behalf of CDPI system and/or product marketer.

Health Care System includes the administrative or business units in the vast network of managed care and insurance reimbursement systems and includes, for example, health maintenance organizations (HMOs), managed care providers, health insurance programs, pharmacy benefit managers, and other provider or payor based programs that can control, in any way, the dispensing of health care services.

Manufacturer includes a manufacturer of a drug or device or the provider of a service. Product shall be understood to include reference to a drug or drug-containing product, a device, a process, or a service.

Health Products Marketing includes the regulated (e.g., by the FDA) means of advertising, promoting, distributing, and selling drugs, devices, and services used in the health care of consumers.

Doctor includes any health care professional with prescriptive authority or influence for health care products or services.

Governmental Regulators and Governmental Administrators refer to those individuals who either regulate or approve (or deny) the marketing of products by manufacturers or services (e.g., Food and Drug Administration), or those State (Insurance Commissioner) or Federal (Health and Human Services) agencies that regulate which products or services must be provided or reimbursed in health care systems (e.g., HMOs) or federal health benefit systems (e.g., Medicare and Medicaid).

In health care systems and health care products markets, there are established methods of transacting various kinds of information transfer, communications, and commerce between the various parties of those systems. Therefore, the objectives of the present invention include:

(1) enabling the consumer in health care products markets to conveniently direct manufacturers and other parties to provide communications and information about products and about related information and services to the attention of professionals designated by the consumers;

(2) enabling the consumer in health care products markets to conveniently identify professionals who are available to provide consultation to them and are already prepared to consult about the appropriate use of specified products;

(3) enabling the consumer in health care products markets to conveniently express preferences regarding products, to aggregate such expressions of preferences with other consumers, to be informed of the results of such aggregation, to establish communication with other interested consumers, to report such results publicly and to professionals health care systems and governmental regulators and administrators for the purpose of influencing deliberations and decisions regarding products;

(4) enabling the consumer to accomplish such transactions either anonymously or confidentially or openly;

(5) enabling manufacturers and other parties to direct product-related communications and information and services (such as sample fulfillment) to professionals at times when the professionals' need for and responsiveness to such communications, information and services is demonstrably immediate;

(6) enabling manufacturers and other parties to accomplish such transactions, coordinated with their other marketing and information provision activities (particularly Internet-mediated activities) while achieving the advantages of outsourcing the transaction processes to a separate business organization;

(7) enabling professionals to be apprised of the consumer's needs for consultation about particular products prior to the times of those consultations;

(8) enabling professionals to optimally match the timing of their continuing education activities, related to the use of particular products, with the timing of consultations with consumers;

(9) enabling professionals to conveniently obtain information and services provided by product manufacturers and also information which cannot, because of regulatory restrictions, be provided directly to professionals by manufacturers; and

(10) providing services of such value to consumers, professionals, manufacturers, and 25 others that the CDPI system will have a strong basis for commercial success.

Consumers who have become interested in the possible use of a health care product and who depend on health care insurers, systems, or professionals for financial payment, approval, consultation, or prescription in order to make use of the product are enabled by the inventive process to exert influence upon the decision-making processes of such insurers, health care systems, or professionals. Simultaneously, through enabling the influence of interested consumers, the inventive process improves the marketing processes of the manufacturer or provider of such product. Simultaneously, by closely matching the presentation of product-related information and marketing services with the timing of an actual clinical need for consideration of the product or service, the inventive process improves continuing education and decision-making processes of health care professionals. By facilitating referral of interested consumers to professionals who are informed and ready to provide consultation regarding the possible use of a product, the inventive process improves convenient access to consultation for consumers, efficient learning, clinical practice, and business for professionals, and efficient marketing for manufacturers. By establishing a source of products-related information which is integrated with these above-mentioned activities and which includes preparation of information through independent authorship and editorial processes, and which includes presentation of such information to segregate it from information provided by product manufacturers, the inventive process creates an accessible means for enabling consumers and professionals to conveniently obtain, evaluate, and act upon information about non-approved uses for products. By enabling the reporting to health care systems of aggregated consumers' preferences and communications regarding a product or service, the inventive process improves consumer participation and consideration of consumer preferences in health care systems' decision-making processes.

In an embodiment of the inventive process, the interactions between the CDPI system and the consumer are accomplished through the consumer's electronic network (e.g., Internet) access, appropriate (e.g., graphical) interface, and personal computer system (including software and hardware) in communication with the CDPI system's network-mediated services and information systems. The intent of the CDPI system is to enable consumers to direct prescription influence transactions. Moreover, as consumers and the professionals and/or health care systems they specify may not share common access to an electronic network communications system, the inventive process fulfills consumer-directed transactions through a variety of media appropriate to the communications capabilities of the specified professionals or health care systems.

(a) Enable the Consumer to Become Informed About a Product.

In one embodiment, the CDPI system provides product-related informational content which is found by consumers using commonly-available Internet web browser software interfaces in personal computers or other interactive devices which are connected to the Internet. The information is drawn from sources including the manufacturer of the product, other authoritative authors and organizations, and content produced or commissioned by the CDPI system. Consumers find such information and the CDPI website(s) providing the information by performing general Internet searches (as through portal sites such as Yahoo!, Netscape, Excite, or Alta Vista) using designated key words (product name or category, disease state, etc.), or by coming directly to the CDPI website in response to marketing of CDPI website(s), or by returning to a previously visited CDPI website, or in response to a recommendation from another consumer or a health care professional. Alternatively, the CDPI website is provided in conjunction with or linked from a manufacturer's product-specific website, to which consumers have come in response to the manufacturer's direct-to-consumer product marketing. Further, different computerized information networks and devices (i.e., other than the Internet and personal computers with Internet browsers) may be used to effect access to a CDPI system information source. Moreover, despite their inefficiency as compared with Internet-mediated communication, voice telephony, written/printed (e.g., mailed), and other methods of information storage, display, and communication are employed to effect the access of consumer to information about a product.

(b) Enable the Consumer to Become Informed About the Availability of Consumer-Directed Prescription Influence Services for that Product.

When the consumer has gained access to information about a product through a particular medium (as described above in (a)) and has become interested in the possible use of the product for treatment of a disease state or health problem, the same or different medium is employed to inform the consumer about the CDPI services which are available for that product. In a preferred embodiment, this occurs immediately and through the same medium used by the consumer to find and/or receive product information. For example, the consumer who has come to a CDPI website or a manufacturer's product-specific website is presented with information about CDPI services in the course of viewing information about the product. Or, a consumer calling a toll-free “1-800” telephone number for product information hears information about CDPI services. It also will be possible to use a different medium for product information and offering CDPI services. For example, a consumer who has come to a product-related website may indicate interest in subsequently available information and may give his/her email address or postal mail address, and a message about CDPI services may be sent to that address, electronically or in hard copy. Conversely, a consumer who has requested “hard copy” of product information, by mailing in a postcard associated with a magazine advertisement and giving his/her email address, may be sent a message about CDPI services in more rapid, Internet-based form.

(c) Enable the Consumer to Choose to Direct One or More Prescription Influence Service Activity.

Once informed about the availability of CDPI services, the consumer is offered the 25 opportunity to direct the transaction of one or more of those services. In a preferred embodiment, this occurs immediately and through the same medium as used for steps (a) and (b). For example, the consumer who has received product and CDPI service information from a product-related website or websites may immediately choose to use the “inform my professional” service, using the interactivity features of the website(s) and his/her Internet access system (computer, software, Internet service connection, and browser). Prompted by the website “Do you want your professional to be informed about this product and about your plan to make an appointment for consultation about your possible use of it?” the consumer will respond “yes” and then directs the specific transaction between the CDPI system and the professional. Alternatively, email, postal mail, voice telephone, and other communication methods are used to communicate with a consumer who has indicated (through any medium) an interest in CDPI services and to effect the offer, choice, and consumer direction of the transaction.

(d) Enable the Consumer to State which Potential Use of a Product is Pertinent to His or Her Interest.

Once the consumer directs the CDPI system to inform a specified professional about a specified product in anticipation of the consumer's consultation with that professional, the inventive process provides to the professional information about all of the product's possible uses. However, in a preferred embodiment, the CDPI system prompts the consumer to indicate the disease state or health problem for which that consumer is interested in using the product. This allows the inventive process to provide more specific information to the professional, reducing the time and effort required for the professional to prepare for consultation, reducing the cost of providing information (particularly hardcopy, postal-mailed information), and increasing the CDPI system's and manufacturer's ability to respond to consumers' and professionals' needs for information, education, and marketing activities related to particular disease states and health problems. Such specificity allows the inventive process (CDPI system) to facilitate formation of consumer interest groups related to specific disease states and health problems and provides the manufacturer better market research information.

(e) Enable the Consumer to Provide Information to Identify a Health Care Professional.

The inventive process optionally comprises a consumer-directed “inform my professional” transaction feature. If such an optional feature is selected by the consumer, the CDPI system will need the consumer's identification of the professional. In a preferred embodiment, the consumer will use the same medium used for steps (a) through (d), or at least steps (b) through (d), to provide this information immediately and allow for verification of identification (see step (f), below) of the professional. For example, the consumer continues interactive use of the product-related website and, after choosing to direct the “inform my professional” transaction and giving disease state information, enters professional identifying information (e.g., name, city, state, address, and/or telephone number) sufficient to identify the professional. Alternatively, the consumer may give information to identify the professional verbally by telephone or in written form by postal mail.

(f) Provide for Verification of the Identifying and Addressing Information for a Professional Identified by a Consumer.

If optional step (e) is utilized by the consumer to “inform my professional” transaction, the CDPI system verifies that the consumer's identification of the professional does, in fact, specify a single individual professional or bonafide group of professionals practicing together. Such verification compares the information provided with a valid database of professionals. A consumer may give insufficient identifying information. For example, a consumer's identification of his or her professional as “Dr. Smith” in “New York” will not be adequate for individual identification and appropriate fulfillment of the transaction directed by the consumer. A consumer may give erroneous information. For example, a misspelled name, a nickname instead of a professional name, an outdated address or telephone number, a mistaken recollection of city location, etc., could preclude accurate identification. In a preferred embodiment, the consumer uses the same medium used for steps (a) through (d), or at least (b) through (d), to provide this information immediately and to allow for immediate, real-time verification of the professional's identity. For example, the American Medical Association's database of doctors of medicine and osteopathy is carefully maintained and updated for accuracy and is available for use in automated and on-line information systems. Real-time, automated reference of the CDPI system controller to that (or a similarly comprehensive and accurate) database allows the system to confirm positive individual identification of the specified professional or, failing that, to prompt the consumer to give additional information, to correct erroneous information, or to select from a list of professionals whose database information most closely matches the information given by the consumer. This allows a positive identification of the specified professional and the professional's address information while the consumer is still in real-time interaction with the CDPI system. Another real-time embodiment of this function would have a consumer in electronic or telephone communication with a CDPI staff person who would refer to electronic or printed database(s) and ask questions by electronic (e.g. through a website interface or email, etc.) communications or telephone to accomplish positive, individual identification of the professional. Further, an additional embodiment of the inventive process uses communication of information from the consumer by any of several media (Internet website, email, postal mail, voice message, etc.) followed by delayed processes (automated and/or staff action) to verify positive, individual identification. Such delayed processes require reestablishment of communication with the consumer to correct ambiguous or erroneous identifying information and, in cases of inability to communicate with the consumer, can result in failures of identification and inability to notify the consumer of the failed transaction.

(g) Enable the Consumer to State the Time Frame in which He or She Expects to Consult with the Identified Professional about the Product and Product Use of Interest to the Consumer.

In effecting the consumer-directed “inform my professional” transaction, the CDPI system will best meet the need for timely provision of information to the professional if the consumer accurately specifies the time when he or she will have an appointment to consult with the professional about the possible use of the product. Through experience in and following many such transactions, the CDPI system will determine the optimal timing for communicating product information to a professional in anticipation of consultation with the consumer, by measuring rates of use of materials, learning efficiency, consumer satisfaction with professional preparation for consultation, effect on prescription behavior, etc. If optimal timing for postal mailing were known to be two weeks prior to the anticipated appointment, the system would effect mailing at that optimal time. In a preferred embodiment, the consumer will use the same medium used for steps (a) through (f) to provide this information immediately.

(h) Enable the Consumer to Review and Correct the Information Provided by the Consumer.

This optional step first requires that the consumer have provided information to the CDPI system. The system will immediately communicate to the consumer (e.g., by display through an Internet browser interface) the information and directions provided by the consumer, for review and confirmation prior to effecting the transaction. This allows the consumer to reconsider, to correct or change any information, and to give final approval for the transaction. In embodiments of the system which do not provide real-time interactivity, verification, and confirmation, this step is less feasible. For example, an embodiment using postal mail for consumer requests and system responses would involve unavoidable delays and perhaps high rates of consumer failure to respond to confirmatory mailings.

(i) Provide Cautionary Information Regarding the Responsibility of Health Care Professionals to Exercise Independent Professional Judgement in the Diagnosis of Disease and the Authorization or Prescription of Products for Treatment.

As an optional step and in concern for regulations, the inventive process can require acknowledgement of above-noted cautionary information and requirement of the role of health care providers and acceptance of terms and conditions of use of CDPI services. In effecting the consumer-directed “inform professional” or “refer to professionals” transactions, the CDPI system avoids giving or implying an to the professional's services or response to the consumer's inquiry about the product of interest. That is, the CDPI system clearly communicates to the consumer that health care professionals have an overriding duty to make independent professional judgements about the disease states or health problems of the consumer and about the appropriate use of prescription products for treatment of the consumer, that professionals conduct their own business and professional practices independently of the CDPI system, and that the CDPI system cannot be responsible for the judgements, actions, or omissions of professionals. Similarly, the inventive process informs consumers of their responsibility for ascertaining that the training, experience, and other characteristics of professionals are appropriate to the individual consumer's interests and needs, to the effect that the system cannot be responsible for the judgements, actions, or omissions of professionals. These cautionary communications effect compliance of the CDPI system with the ethical and statutory separation of health care professionals, in their relationships with consumers, from involvement with or obligations to third parties such as the CDPI system, professionals, health care systems, or product manufacturers. The system also cautions the consumer that the system does not accept responsibility for any damages (e.g., the cost of consultation with professional) arising out of a professional's decision regarding product prescription nor any damages arising out of system failure to effect a consumer-directed transaction. Consumer acknowledgement of reading and accepting these disclaimers as conditions of use of the CDPI system will be a precondition for concluding a consumer-directed transaction. These communications protect the CDPI system from claims of responsibility for any particular outcome of the consumer's direction of the system to effect a transaction or a particular outcome of a transaction. In a preferred embodiment of the present invention, these communications will occur through the same medium used for and at the same time as the consumer's interactive accomplishment of some or all of steps (a) through (g).

(j) Enable the Consumer to Identify Himself or Herself, by Name or by Other Identifying Information, to the Specified Health Care Professional.

In effecting the consumer-directed “inform my professional” transaction, the CDPI system optionally provides more personalized service to the consumer and useful information to the specified professional by enabling the consumer to identify himself or herself to the professional. This communication service option uses a highly effective method and apparatus to maintain the consumer's privacy and confidentiality in protecting against disclosure of identity and disease state or health problem information to unintended recipients of information and in protecting against fraudulent communications of one consumer in place of or about another. One approach to concealing identity will be to avoid actual disclosure of identity by the consumer to the CDPI system. This is accomplished by having the consumer provide a name/identifier (such as initials and medical record number) which will identify the consumer to the specified professional but not to other persons. Alternatively, the consumer can provide an actual name and some separate identifier (such as a medical record number or other information known to the professional and/or a secure intermediary system), allowing positive identification of the consumer as the director of the transaction and author of any associated communication to the professional. To protect identity information as it is sent by consumer to the CDPI system and by the system to the specified professional, secure, encrypted electronic communication (in the preferred embodiment) is used. Alternatively, secure postal or commercial mail may be used for one or both communications.

(k) Enable the Consumer to Create a Message to be Delivered to the Identified Professional.

To optimally match the consumer's need with the professional's receipt and use of product information, the CDPI system may optionally enable the consumer to create a message to be delivered to the professional with the product information. For example, Mr. Smith might wish to mention to Dr. Jones that his Parkinsonian tremor has been intermittently disabling and that he is interested in Dr. Jones' thoughts about a new anti-Parkinsonian drug product. The inventive process creates a mechanism that enables and encourages a consumer to attempt to influence the professional's consideration of prescription of a particular product and provides a coordinated mechanism for effecting that influence, including communication of messages. In a preferred embodiment, the consumer can use his/her Internet browser interface to enter such a message as text or voice email to be securely transmitted with the consumer's identifying information to the CDPI system. Alternatively, the consumer can write a message to be sent to the CDPI system by postal mail or can speak a message to be recorded and/or transcribed by the CDPI system. The system then communicates the message in a manner appropriate to the specified professional's communications capabilities and preferences, such as email, postal mail, voicemail, etc.

(l) Communicate the Information (Product, Disease State or Health Problem, Consumer Identification, Consumer Message, Anticipated Time of Consumer's Consultation with Professional') Provided by the Consumer to the Specified Professional and Provide Related Information from the Product's Manufacturer and other Sources, as Requested by the Consumer and as Deemed Appropriate by the Manufacturer or Other Sources.

The inventive process fulfills the consumer-directed “inform my professional” request by communicating information to the specified professional in a manner appropriate to the professional's communications capabilities and preferences. In a preferred embodiment, the professional's communication capabilities, preferences, and addresses are in a CDPI system database, allowing electronic communication (e.g., email) communication with those professionals who prefer that method, and using postal mail when preferred or necessary for transmittal of information and/or materials (printed and other). The first communication of CDPI system to a particular professional may necessarily be via postal mail. With that communication, the CDPI system queries the professional about preferences for future communications. The accumulation of such information enables communications with increasing numbers of professionals according to their expressed preferences.

Information provided to the consumer-specified professional is product-specific and related to the disease state or health problem identified by the consumer. Further, by creating and maintaining a database record of each “inform my professional” transaction and of each use of information resources by professionals, the CDPI system provides information to each professional which is appropriate to that professional's history of information use. For example, a professional who has previously received a consumer-directed communication about a particular product or disease state can, in a subsequent consumer-directed communication about the same product or disease state, be reminded of the previous communication and be provided with a selected update of information, making the professional's task of topical review more efficient. Similarly, a professional prompted by that communication to make use of the CDPI system's Internet website information resources can be provided with information customized according to his or her prior use of the information resources. For example, product-labeling information may be displayed with text highlighting of labeling changes made since the professional's last prior review of labeling information.

(m) Simultaneous with the Communication of Step (1), Inform the Professional of the Availability of Further Information or Service Resources Related to the Product or Disease State Specified in the Consumer's Request.

Optionally, the professional is also informed of and directed to other sources of information (electronic, printed, etc.) and services (continuing education modules, meetings, manufacturers' representatives, product sampling, etc.) -- via Internet website (of manufacturer, CDPI system, or other sources), postal mail (following request through any suitable medium, such as email, website, return postcard, toll-free “1-800” number, etc.), or other media. When appropriate (that is, to the marketing requirements of the manufacturer), access to such information may be restricted to professionals who have been given electronic password, printed coupon, or other evidence of qualification for access to information or services through the CDPI system. It is anticipated that professionals' familiarity with these sources of information, developed through interaction with the CDPI system, will increase their responsiveness to the CDPI system's consumer-directed transactions and will also increase their spontaneous, unprompted use of these sources.

(n) Create and Provide Information to Consumers and Professionals in a Manner that Maximizes Breadth of Information and Complies with Governmental Regulation of Marketing of Health Care Products.

The United States Food and Drug Administration (FDA) and other governmental 20 regulations of prescription product marketing restrict and regulate the scope of information which may be provided by manufacturers to consumers or health care professionals. Information about “non-labeled” uses of products, that is uses that have not been approved by the FDA, is particularly regulated. To maximize information service to consumers and professionals, the CDPI system optionally will coordinate the creation or compilation of product-related information and services, including information written, edited, and presented in a manner which maintains its editorial and physical separation from information and services provided by product manufacturers, so that such information and services are provided to consumers and health care professionals without violating governmental regulations. For example, the consumer-directed communications to a specified professional can include regulation-compliant marketing materials provided by the product's manufacturer and can also include a message from the CDPI system to inform the professional of the availability (e.g., via website or direct mail, etc.) of other information resources, including information which cannot be directly disseminated by the product's manufacturer. Similarly, an Internet website operated by the CDPI system can offer to consumers a range of information about products' uses which exceeds the range of information which can be disseminated by the products' manufacturers.

(o) Enable the Consumer to Indicate an Interest in Receiving the Names and Contact Information for Conveniently Located Health Care Professionals Who Are Informed About and Prepared to Consult About a Specific Product.

A consumer indicates interest in this CDPI service through media as described in step (c).

(p) Enable a Consumer to Indicate A Health Care Specialty or Specialties or Disease State Expertise of Interest in Finding Informed. Prepared Professionals.

In this optional step, for example, a particular product may be indicated for use in treatment of more than one disease state, and such varied disease states may belong to the areas of expertise of different professional specialists. For example, a beta-blocking medication may be used by a cardiologist to treat cardiovascular disease and by a neurologist to treat migraine headaches, or for both purposes by a primary care professional. In attempting to meet the consumer's need for appropriate referrals, the CDPI system prompts the consumer for information about the disease state or health problem of interest to the consumer and informs the consumer regarding which professional specialties usually maintain expertise in diagnosis and treatment of that problem. The consumer is then prompted to select the professional specialty or specialties about which referral information is desired. The media for communicating and displaying such information are as described in steps (d), (e) and other steps.

(q) Enable a Consumer to Indicate a Locale in or Near Which He or She Prefers to Consult with an Informed, Prepared Professional.

Through communications and display media as described above, the consumer optionally may view information about locations of participating professionals who are prepared to consult about the product or disease state of interest. The consumer is prompted to indicate which geographic area is suitable for his or her access to a referral professional.

(r) Create and Maintain a Database of Information About Professionals Whose Preparation for Disease- and Product-Related Consultation Meets Standards Established by the CDPI System.

An optional response to consumer requests for referrals requires an extensive database (or a plurality of databases) of participating professionals. Professionals will be receptive to referrals of consumers to them and they will, therefore, be willing to meet criteria established for participation. Such criteria are established, for example, by the product's manufacturer and may involve, for example, the professional's meeting with a manufacturer's representative to receive product-related materials, or attendance at a professional education meeting, or completion of an online (e.g., in Internet website) continuing education module about disease state diagnosis and treatment. The recruitment of professionals to participation is a function of the CDPI system, in which case the system builds and fills its own database of participating professionals. Alternatively, the manufacturer's sales force recruits participating professionals and directly or indirectly transfers information to the database. The database is established by the CDPI system or by the manufacturer; in either case, the CDPI system, in a preferred embodiment of the inventive process, effects direct electronic communication with the database to obtain information needed for response to consumer requests.

(s) Provide to the Consumer a List of Informed, Prepared Professionals who meet the Consumer's Stated Criteria.

In a preferred embodiment of the inventive process, the CDPI system effects direct electronic communication with a participating professionals database. Information about professionals appropriate to the consumer's inquiry is then provided to the consumer through an Internet browser and graphical interface in a personal computer system during the same website interaction session and immediately after the consumer communicates selection information to the CDPI system. Other communications media may be used, including nongraphical computer interfaces (e.g., email or alphanumeric displays), printed reports, postal mail, voice telephony, etc. Some such means of reporting may necessitate a delay between consumer request and provision of requested information. If there are insufficient numbers of participating professionals who meet the consumer's selection criteria, a partial listing may be given immediately and the system may prompt the consumer to give address information to allow delayed reporting. In such cases, the CDPI system can then act to recruit more participating professionals, either directly or through the product manufacturer, as described in step (r).

(t) Inform Each Professional of Consumer Inquiries and of Numbers of Consumers Given the Professional's Identifying Information.

This step will motivate professionals for prompt and timely review of product-related information and to motivate continued professional participation in the consumer referral activity. This can be accomplished through communications media appropriate to the professionals' individual communications capabilities and preferences. In a preferred embodiment, this occurs through Internet browser and graphical interface in the professional's personal computer system.

(u) Enable Consumers to Identify Health Care Systems or Health Insurers.

Fulfillment of the foregoing transactions requires building and filling a substantial database with information about the business names and operational territories of multiple insurance companies, health insurance products, and health care systems, and about these businesses' coverage or formulary inclusion of particular products. Such databases may be created and maintained by the CDPI system or by manufacturers or other parties, and the CDPI system requires access to such database(s) in order to respond to consumer requests for information. In a preferred embodiment of the inventive process, the consumer and CDPI system communicate with each other through Internet website and appropriate interfaces, as described above, and the CDPI system effects access to the database by direct and immediate electronic communications. The consumer is prompted to provide sufficient information about the insurance plan or health care system of interest, to allow the CDPI system to positively identify a single match in its database.

This is similar to the process for positive identification of a specified health care professional from that CDPI database, as described in steps (e) and (f). Depending on the level of detail required to respond to the consumer's inquiry, the information required may include name of plan or system, geographical service area, consumer's insurance group number, consumer's employer, etc.

(v) Enable Consumers to Inquire About the Availability of Particular Products in the Insurance Coverage or Product Formularies of their Health Care Systems.

In the case of a consumer whose access to the CDPI system has been effected through a product-specific communication, the product specificity will be known to the system. In other circumstances (e.g., consumer access through a website with information about many products), the consumer will be prompted to indicate which product is of interest. Because insurance or health system coverage or formulary inclusion of a product may be related to disease state (i.e., covered for treatment of one disease state and not for another), the consumer may also be prompted to indicate which disease state or health problem is of interest. Given this information, the CDPI system can refer to a database of product coverage and formulary inclusion information and report to the consumer.

(w) Enable Consumers to View the Aggregated Expressions of Other Consumers' Preferences for a Particular Product. Generally and Related to the Health Insurers and Health Care Systems of the Inquiring Consumers.

The database of information about health insurers and health care systems will also include accumulated information about consumers' expressions of interest in particular products. This information can be displayed on request. For example, Mrs. Smith may wish to know how many other consumers have expressed preference, through the CDPI system, for coverage of a product's use. She may wish to know specifically how many other consumers covered by her health insurer or health care system also have expressed preferences for coverage or formulary inclusion of the product's use for a particular disease state. With this information, which constitutes an indication of aggregated consumer opinion, Mrs. Smith may feel that she can approach the administrators of her insurance plan or health care system to call for consideration or reconsideration of coverage or inclusion of the product.

(x) Enable the Consumer to Express his/her Preference for Product Inclusion in Insurance Coverage, Formulary, and Add that Consumer's Expression of Preference to the Appropriate Database Categories.

This optional transaction allows the consumer to direct his/her expression of product-related preference. The expression of preference may include not only counts of “votes” for product coverage/inclusion but also text of consumer comments about product, health system experiences, and messages directed to other consumers, health insurers, or health system personnel. For example, Mr. Jones may wish to report to other consumers his experience with attempting to establish coverage for use of a product in treating his cancer. In a preferred embodiment of the inventive process, this is accomplished through Internet service access, web browser, graphical interface, and personal computer system in communication with the CDPI system's website services and information systems.

(y) Enable the Consumer to Send Messages, With or Without Personal Identification, to Personnel of Health Insurance Companies or Health Care Systems.

This transaction, similar to steps (j) and (k), allows consumers to direct comments about product coverage or formulary inclusion, through the CDPI system, to the attention of designated personnel of health insurers or health care systems. Such messages can be, at consumer discretion, posted in the CDPI system for other consumers to see. These transactions will require enabling consumer entry of or reference to names, titles, and addresses of the recipients of the messages and, in a preferred embodiment, the creation and maintenance of a CDPI database of designated personnel (e.g., pharmacy managers, CEOs, Pharmacy and Therapeutics Committee chairpersons, etc.) to whom such messages may be directed.

(z) Enable Consumers to Indicate Whether they Wish to be Informed about Future Events Regarding the Specified Product and the Specified Health Insurer or Health Care System.

The inventive process allows consumers to enter their addresses (email or other) in the CDPI system so that the system may later relay messages to them about requested information (about products, professionals, disease states, or health care systems) or from other interested consumers, while maintaining the consumers' addresses and identities as confidential information.

(aa) Enable Consumers to Send Messages to Groups of Similarly Interested Consumers to Share Information and Attempt to Form an Active Interest Group.

For example, Mrs. Smith may wish to organize and coordinate the activities of an interest/advocacy group regarding a product or related disease state for consumers in her health care system. The CDPI system can enable her to send a message (perhaps describing her interest, knowledge of the health care system's decision-making processes, proposals for action, and plans for an ongoing electronic discussion or actual meeting of consumers) to other interested consumers of Mrs. Smith's health care system who have given their addresses (email, postal mail, etc.) to the CDPI system for that purpose. The CDPI system can relay such messages while maintaining consumers' addresses and identities as confidential. The CDPI system can continue to provide email communications or website display of information about the group's ongoing activities.

The foregoing process provides an opportunity to propose that manufacturers apply the CDPI system to the marketing of their products. The value to the manufacturers of the CDPI system in facilitating consumer-directed influence of product prescription will provide a basis for the CDPI system's commercial success.

Accordingly, in one aspect of the invention, a process is provided for (1) facilitating consumer and professional interaction and communication about products and services that require a professional decision before a consumer can purchase or be prescribed a particular product or service by a professional, or (2) facilitating the marketing of regulated products by manufacturers to professionals, consumers and health care systems, or (3) providing consumers with a means for influencing decisions of professions and health care systems with respect to providing a product or service and having the product or service available with a particular health care system program. The process comprises the step of providing a direct-to-consumer and professional health care product or service information source having a connection or a link to a transaction-based consumer and manufacturer product or service communication/transaction service. The process also includes the step of providing the transaction-based consumer and manufacturer product or service a communication service having a consumer transaction menu listing potential transactions selected from the group consisting of (i) informing a professional about a consumer's interest in a particular product, service or disease state, (ii) providing the professional with information about the particular product or service, (iii) providing the consumer with identification of professionals who have been informed about a particular product or service, (iv) providing consumers with a means for communicating health care product or service preferences and desires to health care systems and professionals who have the means or authority to prescribe, specify, authorize, cover (bear the cost of), restrict, prohibit or exclude products for use by consumers and reimbursing for covering the costs of such health care products and services, (v) providing the means for consumer aggregations to form interest groups to influence health care systems and professionals with regard to consumer availability of products and services, (vi) providing the means for the consumer to communicate with appropriate governmental regulators or administrators of such products or services, and combinations thereof. The process further includes the step of allowing a consumer an ability to complete one or a plurality of transactions.

Preferably, the transaction-based consumer and manufacturer product or service communication service further provides the consumer the means for providing his or her identity to manufacturers, professionals and health care systems or not providing his or her identity to any or all of the selected manufacturers, professionals and health care systems. Preferably, the transaction of (i) informing the professional about a consumer's interest in a particular product, service or disease state provides the professional with information from the manufacturer of the product or service, such information from the manufacturer having been approved by an appropriate regulatory agency. Most preferably, such information is supplemented by product coupons or vouchers for consumer use, and provision of such materials is coordinated with provision of product samples to the consumer's identified health care professional by mail or by a manufacturer's sales representative. Most preferably, the information provided to the health care professional is supplemented by independent (of manufacturers) research concerning the product, service or disease state from published medical literature. Preferably, the system will also enable the manufacturer to accomplish the transaction of informing the health care professional about the immediate interest of a consumer (identified or not) in a product, service, or disease state on the basis of the consumer's indication of interest and with information about the identity of the consumer's health care professional (obtained by the consumer's direct provision of that information or from another source such as a health system database), even if the consumer does not overtly direct the provision of information to the professional. In such instance, the transaction of informing the identified health care professional would proceed on the basis of implied consumer-direction.

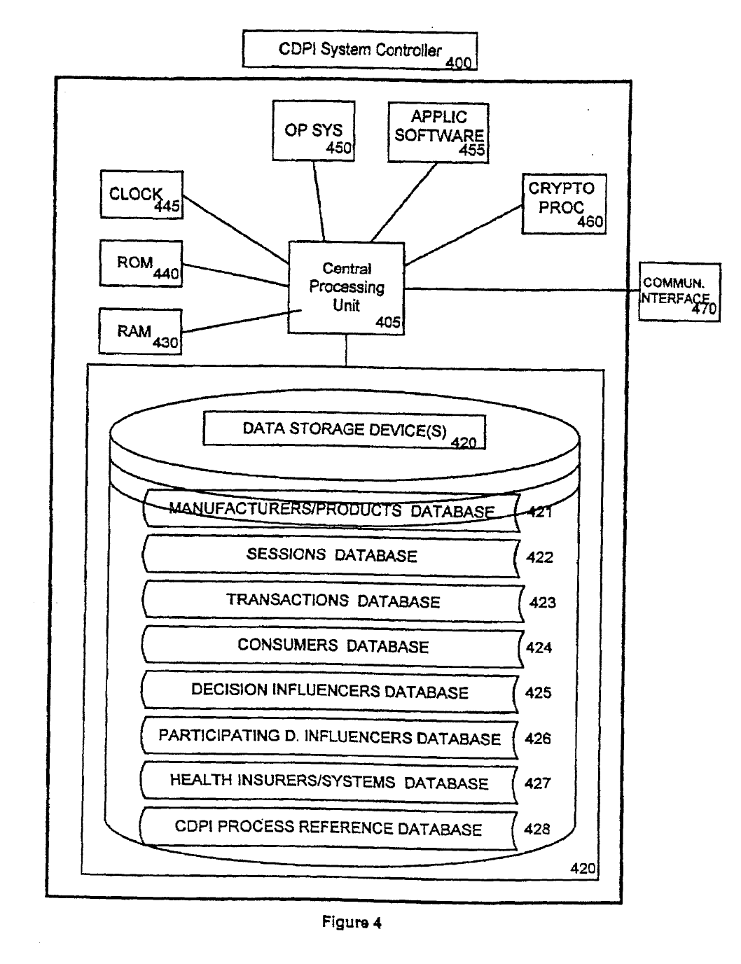

Preferably, the transaction (ii) to provide information about a consumer's interest in a particular product, service or disease state further comprises the step of consulting a manufacturer's/products database to determine if a participating manufacturer subscribes to the transactions service. Preferably, the transaction (ii) to provide information about a consumer's interest in a particular product, service or disease state further comprises the step of consulting a professionals database, which is one type of decision influencers database as described below in connection with FIG. 4, to determine if a professional selected by the consumer is known in the database as a licensed professional able to provide the service or prescribe the product selected.

Preferably, the transaction (iii) to provide the consumer with a list of professionals who have been informed about the selected product or service further comprises the step of consulting a participating professionals database, which is one type of participating decision influencers database as described below in connection with FIG. 4, to find a list of professionals who have received information about the selected product from its manufacturer, are prepared to provide consultation, and have indicated their willingness to participate in the referral system. Most preferably, the list or professionals provided to the consumer are further selected on the basis of geographic area taken from addresses listed in the professionals database and other criteria (e.g., specialty, gender, language, ability, etc.).

Preferably, the transaction (iv) to inform either or both of a consumer's health care professional or heath care system (e.g., health insurance plan, HMO etc.) of the consumer's desire and need to have a particular product or service available to the consumer under the consumer's health care system, further comprises the step of consulting with a health insurer/systems database to insure that the consumer's wishes are correctly transmitted to the correct recipient. Preferably, the transaction (v) to make other consumers in a relevant interest group aware of a product or service and aggregate such consumers into an interest group further comprises the step of identifying interested consumers to each other and facilitating communication between them but not necessarily to the health care system or health care professional.

The present invention further provides an apparatus or server system for implementing the transaction-based consumer and manufacturer product or service communication service over a wide area network or over telephone and mail means of communication, wherein the server system comprises a central processing unit, ROM, RAM, and a data storage device, wherein the data storage device comprises one or a plurality of databases selected from the group consisting of a manufacturers/products database, a consumers database, a decision influencers database (such as a professionals database), a participating decision influencers database (such as a participating professionals database), a health insurers/systems database, and combinations thereof. Preferably, the apparatus or server system data storage device is able to complete transactions i-vi and comprises each of the manufacturers/products database, the consumers database, the decision influencers database, the participating decision influencers database, and the health insurers/systems database. Most preferably, the apparatus or server system data storage device further comprises one or a plurality of a sessions database, a transactions database, a CDPI process reference database, and combinations thereof.

Figure Diagrams and Flow Charts

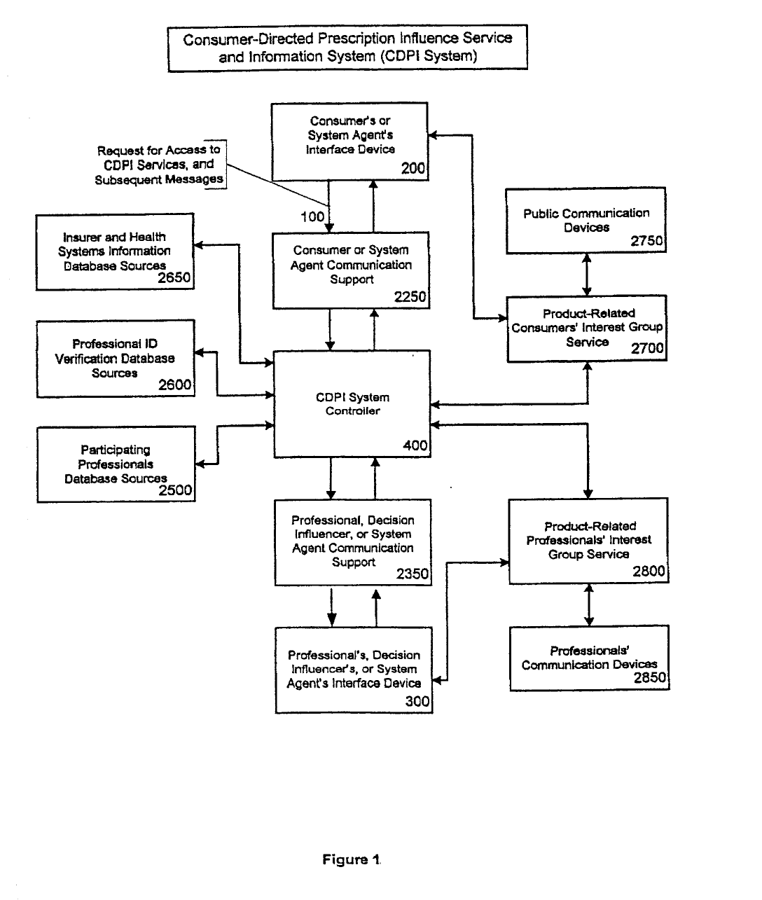

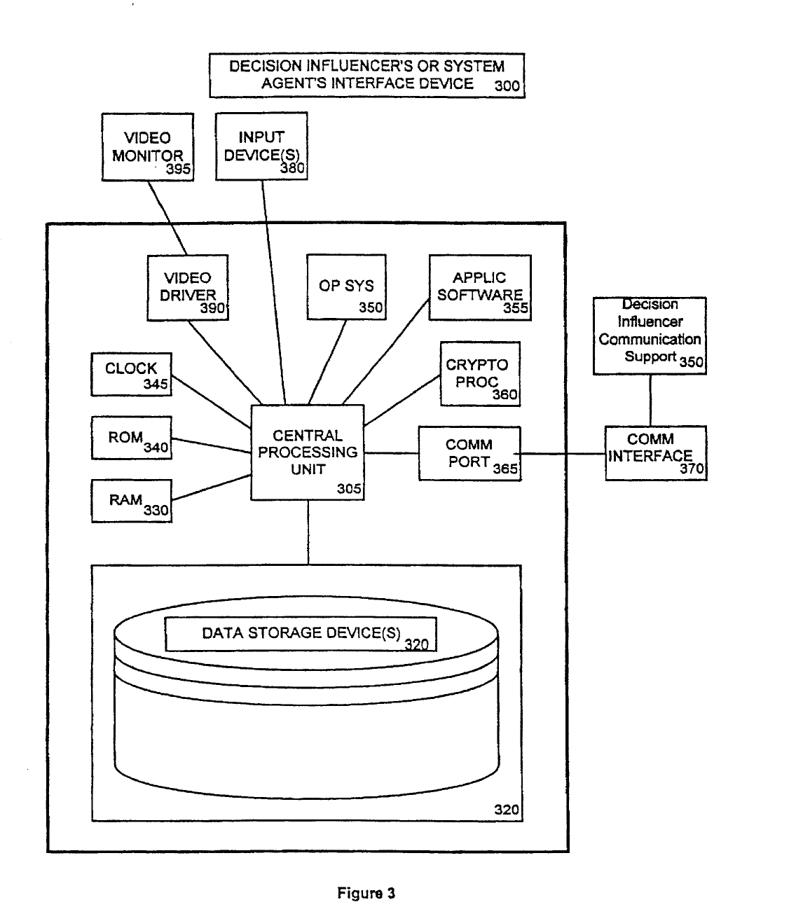

The inventive apparatus is illustrated in FIGS. 1-4. In a preferred embodiment, the present invention includes CDPI System Controller 400; Consumer's or System Agent's Interface Device 200; CDPI System's Consumer or System Agent Communication Support 2250; Professional's, Decision Influencer's, or System Agent's Interface Device 300; CDPI system's Professional, Decision Influencer, or System Agent Communication Support 2350; associated databases (Insurer and Health Systems Database Sources 2650, Professional ID Verification Database Sources 2600, and Participating Professionals Database Sources 2500); Product-Related Consumers' Interest Group Service 2700 accessible to Public Communication Devices 2750; and Product-Related Professionals' Interest Group Service 2800 accessible to Professionals' Communication Devices 2850.

The present invention enables a product-interested consumer to direct CDPI system transactions to exert influence on the processes of health care product consideration, selection, formulary inclusion, insurance coverage, prescription, and consumer advocacy including consumer advocacy to governmental regulators and administrators. In a preferred electronic network (e.g., Internet) embodiment, the present invention renders provision of such service commercially feasible and practically convenient for consumer use.

Network Architecture

The components of a preferred embodiment of the present invention are illustrated in FIGS. 1-4. As illustrated in FIG. 1, the apparatus of the present invention includes Consumer's or System Agent's interface Device 200, Central System Controller 400, and a Professional's, Decision Influencer's, or System Agent's Interface Device 300. These devices may communicate using one or more of such systems as postal mail, public telephone networks, the Internet, cellular and/or satellite data transmission links, etc.

As shown in FIG. 4, Central System Controller 400 includes Central Processing Unit (CPU) 405, random access memory (RAM) 430, read-only memory (ROM) 440, clock 445, operating system 450, application software 455, cryptography processor 460, communications 25 interface 470, and data storage device(s) 420.

A standard personal computer or computer workstation with adequate processing power and memory may be used as Central System Controller 400. In one embodiment it operates as a web server, receiving and responding to consumer requests 100 for access to CDPI services.

Central System Controller 400 must be capable of rapidly performing database queries as well as 30 handling input and output needs. A Sun Microsystems 300 MHz UltraSparc II processor may be used for CPU 405. A similar processor such as a 500 MHz Compaq Alpha 21164 or 450 MHz Intel Inc. Pentium II may also be used.

Cryptography processor 460 may be configured as part of CPU 405 or utilize a dedicated processor such as a Semaphore Communications Roadrunner 284 or VLSI Technology 6868.

Cryptography processor 460 is used to encrypt potentially sensitive data during transfer between Consumer's or System Agent's Interface Device 200 and Central System Controller 400, as well as between Professional's, Decision Influencer's, and System Agent's Interface Device 300 and Central System Controller 400.

Operating system 450 provides application software 455 with interface to CPU 405, data storage devices 420, RAM 430, ROM 440, clock 445, and communications interface 470. In one embodiment, operating system 450 may be a commonly available system such as Sun Microsystems' Solaris 7. Possible alternatives include Microsoft Corporation's Windows NT Server or Compaq's Digital UNIX.

Application software 455 consists of software needed to carry out functions of central controller 400. This software may include database management software, such as Oracle Corporation's Oracle8, web server software such as Netscape Communications Corporation's Enterprise Server, and custom-developed applications needed to handle consumer requests 100 for access to CDPI services.

Data storage device(s) 420 consist of storage media such as hard disk magnetic storage, magnetic tape, or CD-ROM drives. Data storage device(s) 420 consist of databases used in the processing of transactions in the present invention. The databases can be primarily structured collections of information stored by electronic or electromagnetic means. The information can be stored in so-called relational databases or in simple data table or spreadsheet formats. The databases preferably are accessible to the CDPI system through immediate, automated communications media (e.g., electronic or optical). The databases also can be structured collections of information stored by other means and can include information accessible to the CDPI system through human interfaces. Information in the databases can be either accessible on an immediate basis or on a delayed or variable basis, depending on the context. One or more databases given separate designations (names, numbers) for purposes of discussion in this application may be subsets of one or more larger databases.

In the preferred embodiment, these databases consist of a Manufacturers/Products Database 421, a Sessions Database 422, a Transactions Database 423, a Consumers Database 424, a Decision Influencers Database 425, a Participating Decision Influencers Database 425, and a Health Insurers/Systems Database 427. Software such as the aforementioned Oracle8 may be used to create and manage these databases. Data storage device also contains 20 operating system 450 and application software 455.

Manufacturers/Products Database 421 contains data on products within the system for which information is made available by the CDPI system to consumers and professionals. It contains for each product multiple fields such as a unique key, product name, manufacturer, product descriptive fields, pharmacological categories, disease state indications, text/images/layout of marketing materials, authoritative monographs, etc. This information can be entered by data transfer from manufacturer, or keyed entry by CDPI system personnel, or by other systems for data input.

Sessions Database 422 contains information about the timing and flow of each session of interactive (in a preferred embodiment, online) communications between a consumer and CDPI System Controller 400. It contains information fields such as unique key, consumer identification number, times, date, options offered to and choices made by consumer, etc. This enables tracking of system experience with various consumers and analysis of patterns of session events as related to variables in format, sequencing, and content of the information and service options offered to consumers. This information is automatically stored by application software 455 whenever an 35 interactive communication session occurs.

Transactions Database 423 contains data on each interaction directed by the consumer and handled by the CDPI System Controller 400. It contains fields such as a unique key, consumer identification number, time, date, and transaction type. The information in this database is primarily used for fulfillment of transactions directed by consumers and also enables historical or statistical tracking of transactions handled by the system. This information is automatically stored by application software 455 whenever a transaction takes place.

Consumers Database 424 contains data on each consumer to have used the system. It contains fields such as a unique key, “cookies” placed in the consumer's computer memory by the CDPI System Controller 400, and any information provided by the consumer, such as name, e-10 mail address, phone number, address, professionals, message texts, etc. The consumer, using Consumer's Interface Device 200, enters this information which is then stored by the application software 455.

Decision Influencers Database 425 contains data on all decision influencers with whom the CDPI system has had or has been directed to have contact. The Decision Influencers Database 425, for example, can include data about health care professionals. It contains fields such as a unique key, name, address, phone number, e-mail address, practice location, specialty type, disease states and products specified by consumers to be of interest, “cookies” placed in the professionals' computer memories by CDPI System Controller 400, etc. This information may be entered by consumers in their contacts with CDPI System Controller 400 through Interface Device 200, obtained by query of an external database (e.g., Professional ID Verification Database Sources 2600), entered by professionals in their contacts with CDPI System Controller 400 through Interface Devices 300, entered by CDPI system personnel through keyboard entry, transferred electronically from manufacturers' databases, etc.

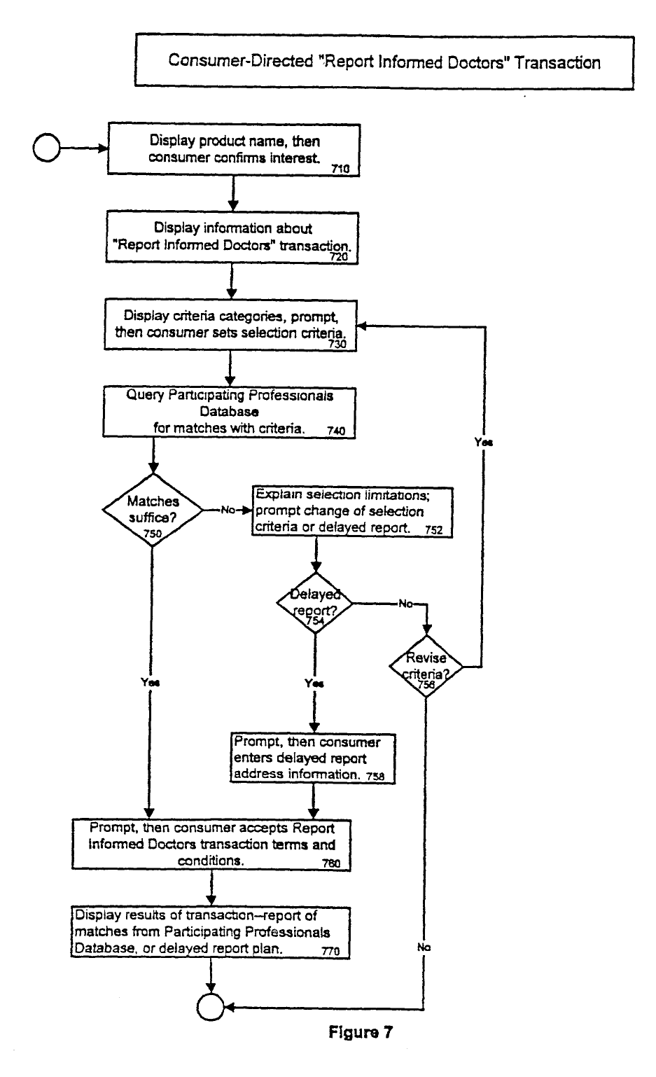

Participating Decision Influencers Database 426 contains information about decision influencers who have satisfied CDPI system criteria. For example, the Database 426 can contain information about doctors who have qualified for consumer referrals through the “Report Informed Doctors” Transaction (FIG. 7). It contains fields similar to the Decision Influencers Database 425, adding fields such as doctor qualifications for referrals and doctor history of consumer referral transactions. This information may be entered by CDPI personnel, by doctors in the course of completing a qualifying activity such as an online product-related continuing education module, by electronic transfer from manufacturers' data systems, etc.

Health Insurers/Systems Database 427 contains data on which health insurance companies cover (provide reimbursement or payment for) which products. It contains fields such as a unique key, insurer name, geographic areas, plan and policy types, covered products, disease states indicating covered use, professionals participating in the plan, etc. Related to health care systems, similar information fields are filled and maintained, including formulary inclusion/exclusion information, criteria, text of available policies/procedures, etc. This information may be entered by CDPI personnel, manufacturers' personnel, or electronic transfer from external data sources. It may include consumer-entered reports of experiences with insurers and health care systems.

Communications Interface 470 is the connection through which the central controller 400 communicates with Interface Device 200 and Interface Device 300. In a preferred embodiment, Communications Interface 470 is connected using high-speed data lines such as T1 or T3 lines to the Internet. In this preferred embodiment, communications will be handled by commercial web server hardware and software, assisted by custom software. Communications Interface 470 may also be configured other ways such as an interactive telephone response system or electronic mail automated messaging system.

Although the above embodiment describes a single computer, the Central System Controller 400 functions may be distributed across more than one computer system. In another embodiment, the central controller might consist of separate systems each handling a specific task, such as a database system and a web server system. Multiple systems may also be used in each role to provide redundancy in case of connectivity or hardware failures.

Interface Device 200 is the system by which a consumer or system agent interacts with the Central System Controller 400. In an ideal embodiment, the device is a traditional personal computer, comprised of input devices 280 such as keyboard and mouse, spoken voice input, and biometric or voice recognition devices to effect individual identification, as well as a CPU 205, RAM 230, ROM 240, operating system 250, video monitor 295, data storage device 220, and communications interface 270. The Interface Device 200 may also be a telephone, fax machine, or other communications equipment. Use of the Interface Device 200 contemplates direct interaction of a consumer with an automated CDPI system interface (e.g., personal computer and web browser connection to CDPI Internet site, or interactive voice response telephone interface) or consumer interaction with a system agent, whether aware of CDPI system or not, and whether intending to make use of CDPI services or not.

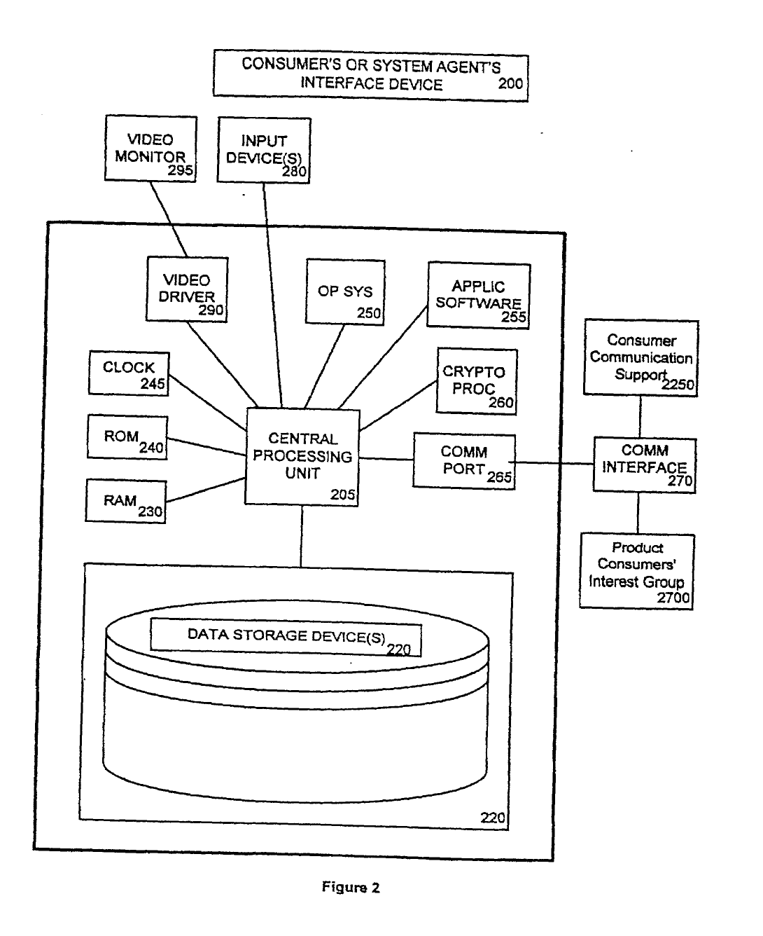

In the described Interface Device 200 of FIG. 2, central processing unit 205, RAM 230, ROM 240, video driver 290, and video monitor 295 can be any combination sufficient to run operating system 250 and applications software 255. Communications Interface 270 may be a traditional modem, connected via standard telephone lines to the internet, or other means of communication such as Asymmetric Digital Subscriber Line (ADSL) or Integrated Services Digital Network (ISDN).

In one embodiment, the consumer's personal computer would be running application software 255 such as Netscape Communications Corporation's Communicator web browser, Microsoft Corp.'s Internet Explorer web browser, or other Hypertext Markup Language (HTML) compatible web browser. In other embodiments, the device might be a similarly configured computer system interacting through an e-mail package such as Microsoft Corporation's Outlook or International Business Machines' Lotus Notes.

Interface Device 300 is similar to Interface Device 200. Interface Device 300 can be a traditional personal computer, comprised of input device(s) 380 such as keyboard and mouse, spoken voice input, and biometric or voice recognition devices to effect individual identification, as well as a CPU 305, RAM 330, ROM 340, clock 345, operating system 350, video monitor 395 and video driver 390, data storage device 320, cryptographic processor 360, communications port 365 and communications interface device 370. Interface Device 300 can also be a “dumb terminal,” personal digital assistant, telephone, fax machine, or other communications equipment. Interface Device 300 enables a decision influencer, such as a professional, to interact with the CDPI System. Use of the Interface Device 300 contemplates direct interaction of a decision influencer with an automated CDPI system interface (e.g., personal computer and Web browser connection to CDPI Internet site, or interactive voice response telephone interface) or decision influencer interaction with a system agent, whether aware of CDPI system or not, and whether intending to make use of CDPI services or not.

Online Embodiment

In one embodiment of the present invention, communications between a consumer and the CDPI service system take place through electronic networks, with CDPI System Controller 400 acting as a network server. With reference to FIG. 1, Interface Device 200 is most often an Internet-connected personal computer, as diagrammed in FIG. 2, communicating by modem through a dial-up or other electronic link to the Internet and thereby to Communication Support 2250. In this case the Internet webserver is controlled by CDPI System Controller 400 via its communications interface 470. Alternatively, the Interface Device 200 can be a “smart” or “dumb” computer workstation on a non-Internet network (e.g., a 10 corporate intranet or a pharmacy chain's wide area network), communicating with a network server which in turn communicates with Communication Support 2250 and CDPI System Controller 400 through non-Internet or Internet channels. In any case, “online” implies that the consumer has a real-time, interactive connection to CDPI System Controller 400, enabling the consumer to send a variety of instructions and information 100 to it, including the initial instruction to provide information and access to CDPI services and subsequent instructions, and enabling the consumer to receive information from CDPI System Controller 400. The same Interface Device 200 enables online communication with Product-Related Consumers' Interest Group Service 2700, which may be operated in cooperation with CDPI Service but not necessarily under the control of CDPI System Controller 400.

A consumer initiates contact with CDPI Service Controller 400 through any of several online strategies. The consumer may have used an Internet search engine service (such as Yahoo! or Alta Vista) to find a specific health care product by name, then chosen to visit a particular website. The consumer may have visited a website, perhaps one controlled by CDPI Service Controller 400, known for its comprehensive offerings of information and services related to health care products. Or the consumer may have searched for information about a particular health or disease state and then, finding that a product may be indicated for treatment, linked to product-specific information. Alternatively, the consumer, having become aware of the Internet URL of a product-specific website as a result of the manufacturer's direct-to-consumer product marketing, has visited that website. In any of these contexts, the consumer is given information about and an invitation to use CDPI services. The consumer's positive response to that invitation results in Interface Device 200 being linked directly to a CDPI service website or in being simply “windowed through” to the CDPI service's functions without technically “leaving” the Internet browser connection with the originating website. For example, a manufacturer's product-specific website may offer CDPI services to visiting consumers and then facilitate a consumer's interaction with Communication Support 2250 and CDPI Service Controller 400 through a “window” in the product-specific website, and then maintain connection with the consumer upon closing of the “window” after completion of interactions with CDPI Service Controller 400.

Continuing with description of the online embodiment of the CDPI System diagrammed in FIG. 1, it is seen that CDPI Controller 400 is in electronic communication with sources of information needed to complete consumer-directed transactions. Communication links may be local or distant, networked, Internet-mediated, or otherwise. The information sources include:

Professional ID Verification Database Sources 2600 are the sources of information about professionals' names, academic qualifications, licensure, specialties, addresses, phone numbers, etc. For example, the AMA maintains and frequently updates such a database for all MDs and DOs in the United States; it is made available on a subscription basis online or on CD, through several vendor companies. Similar databases are available for other categories of health care professionals. Decision Influencers Database 425 (FIG. 4) contains professionals information derived from queries of Professional ID Verification Database Sources 2600 and from CDPI System Controller 400 interactions with consumers and professionals via their interface devices 200 and 300.

Participating Professionals Database Sources 2500 are the sources of information about which doctors are participating in product-related consumer referral programs (i.e., which doctors have met CDPI system criteria as informed or experienced in the use of a product, willing to receive new consumer referrals, etc.). The sources of such information would typically be the products' manufacturers. For example, a manufacturer's sales force may report participating doctor information to Participating Professionals Database Sources 2500 via interfaces including Internet-connected computers, telephone message system, etc. Alternatively, a doctor may be invited to qualify as a participating professional by completing a continuing education program (online or otherwise) which includes information about the product and the disease state(s) for which it is indicated. A manufacturer may independently maintain a database of participating professionals and make it available on a network or secure Internet server functioning as Participating Professionals Database Sources 2500 for CDPI System Controller 400 to query as needed. Alternatively, server 2500 may be a part of the CDPI system's information system. In any case, Participating Decision Influencers Database 426 (FIG. 4), internal to CDPI System Controller 400, contains information obtained by queries of Participating Professionals Database Sources 2500.

Insurer and Health Systems Information Database Sources 2650 are the sources of information about health insurers' and health care systems' coverage and formulary inclusion policies concerning particular products. Typically, this information is provided by manufacturers as a consequence of the information gathering activities of their sales forces. Alternatively, it is provided by consumers' reports of experience with their insurers and health care systems, or it may be legally mandated that insurers and health care systems make such information open to the public. Server 2650 may be controlled by CDPI System Controller 400 or may be independently maintained and is, in a preferred embodiment, available through network or other automated connection for CDPI System Controller 400 to obtain information as needed by query. Health Insurers/Systems Database 427 (FIG. 4), internal to CDPI System Controller 400, contains information obtained by such queries.

CDPI System Controller 400 is in communication with Product-Related Consumers' Interest Group Service 2700, to facilitate consumer access to product-related information and to CDPI system services. For example, a consumer who has interacted with an interest group website 2700 may be informed about and linked or “windowed” to CDPI system services. A consumer who has made use of CDPI services may be informed about and linked by request to an interest group (e.g., disease state, health system advocacy, or product buyers' club). In a preferred embodiment, Product-Related Consumers' Interest Group Service 2700 is accessible to consumers by Public Communication Devices 2750 which include Internet-ready personal computers, network workstations, automated or voice telephony, direct mail, etc., meeting the needs of a variety of consumers and situations.

Similarly, CDPI System Controller 400 is in communication with Product-Related Professionals' Interest Group Service 2800, to facilitate fulfillment and effectiveness of consumer-directed transactions with CDPI System Controller 400. For example, a consumer's “Inform Professional” transaction results in a CDPI System Controller 400 communication with the consumer-specified professional. This communication includes information about the product of interest to the consumer and directs the professional to information and service resources available through Product-Related Professionals' Interest Group Service 2800. In a preferred embodiment, the professional then connects to service 2800 via an online connection (Professional's Communication Device 2850) to obtain such additional product-related information and services. Alternative embodiments allow for such transaction fulfillment and interest group communications to occur, as needed, by telephone, fax, postal mail, etc.

Consumer-Direct Prescription Influence Process

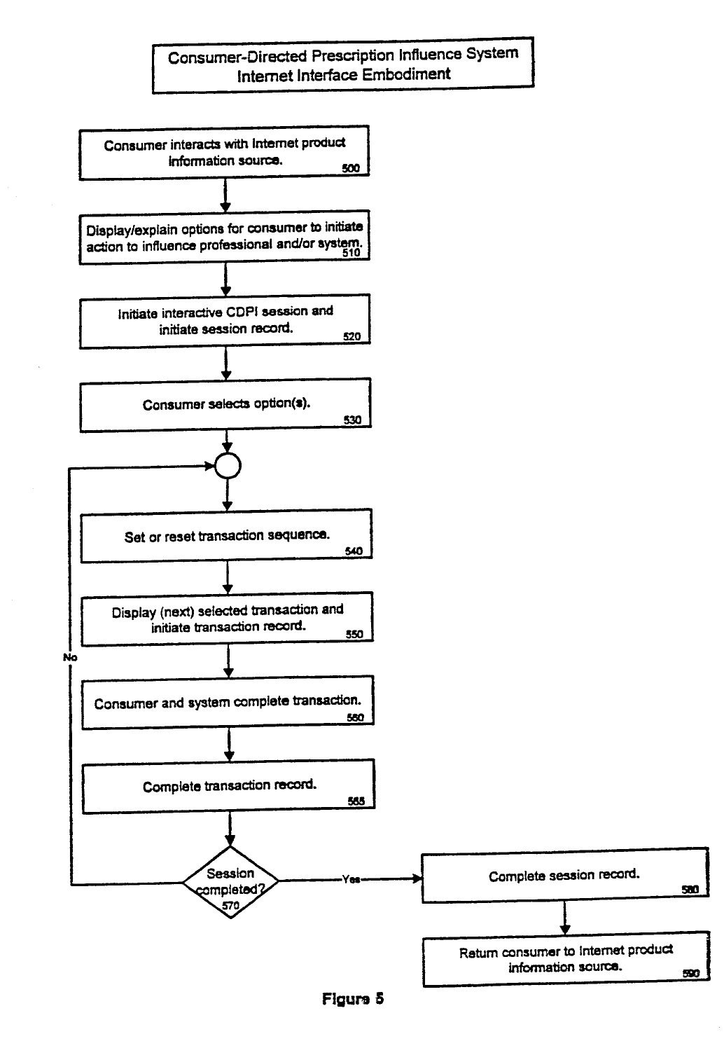

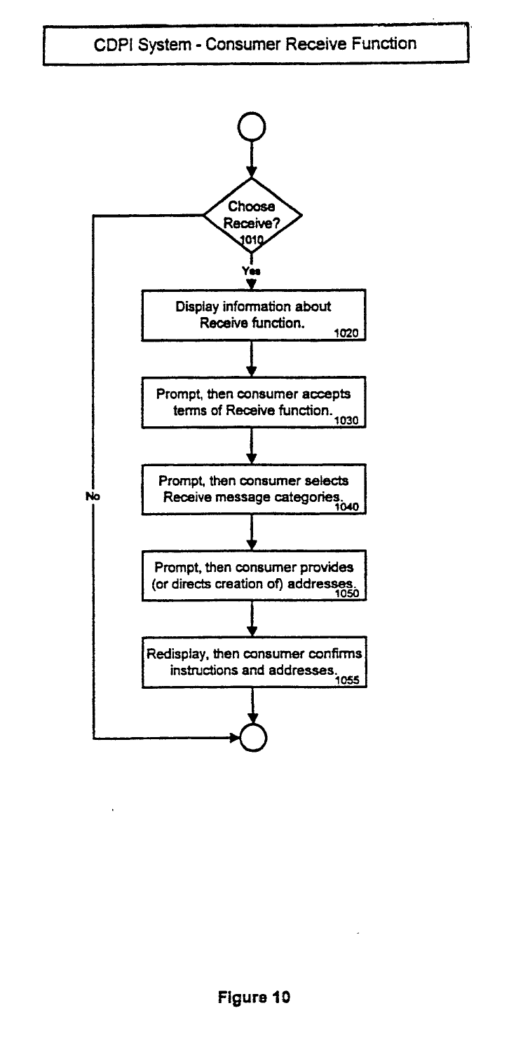

An embodiment of the CDPI process is described in FIGS. 5-11 and in co-pending U.S. Ser. No. 09/224,396, incorporated by reference herein in its entirety. FIG. 5 shows the overall process for a consumerinitiated transaction or transactions over an Internet means of communication with a CDPI website. With reference to FIG. 5, a consumer initiates gathering of information about a product or a particular disease state from any number of means 500, such as product website, broadcast advertisement, print advertisement or referral. The product information source provides a means for the consumer to influence his or her professional or health care system to allow the consumer to obtain a particular product or service of interest. Such a means is referral or link to a CDPI website 510 through a referral web address or direct link to a CPI website server.

The consumer is then linked to a CDPI website process and can choose to begin a transaction or simply be informed of the various professional inform or health care system inform transaction services provided through such a site. The consumer chooses to initiate a transaction session 520 and a session record is initiated in a sessions database 422. The consumer selects various options available, as described herein, and proceeds with the transaction 530. Such transaction can be a simple one of informing the consumer's professional (e.g., primary care physician in a health maintenance organization (HMO)) of an upcoming visit and desire to consul about the possible use of a new pharmaceutical, e.g., Viagra®. The CDPI process “informs” the selected professional of the upcoming visit, preserves consumer confidentiality if requested, and provides product information to the professional if the professional so desires. Alternatively, or in addition, the CDPI process can initiate and complete a transaction that will refer the consumer to professional in the consumer's chosen geographical area who has been informed about a particular product of interest and can see the consumer to evaluate the consumer for a prescription. Once a transaction is completed, the CDPI process asks the consumer if another transaction should be conducted. If there is another transaction, the CDPI process resets the transaction sequence 540, displays the next selected transaction and initiates an additional transaction record in the transactions database 423. Alternatively, the session can be completed 570, wherein the session is recorded 580, and the consumer is optionally returned to the Internet product information source 590.

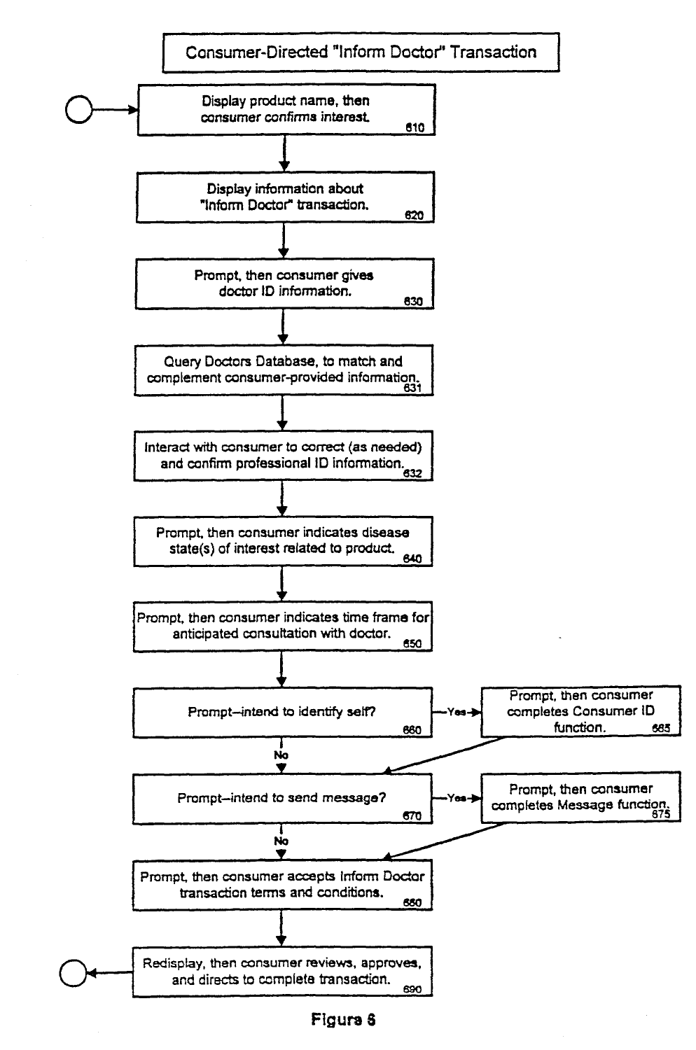

With regard to FIG. 6, this sets forth the process for informing a professional about a particular product or service when the consumer wishes his or her professional to be aware of the product or service and plans to discuss it at an upcoming appointment with the professional. The consumer first confirms his or her interest 610 and the transaction instructions appear 620. The consumer gives the information he or she is aware of for the particular professional (doctor) 630.

Database 425 is queried 631 to provide a match for a professional with the information the consumer provided. The professional information is corrected as needed and the identification of the professional is confirmed 632. The consumer than provides information for the disease state(s) of interest relating to the product 640 and the anticipated time frame of an appointment with the professional 650. The consumer then has a choice of whether or not to identify himself or herself 660 and if the consumer decides to identify himself or herself, a message block to the professional is provided 665. The consumer can also send a message to the professional without identification as to the identity of the consumer 670, 675. The consumer is provided with the transaction service terms and conditions 680 and the consumer is given a final chance to review the transaction before it is completed 690.

With regard to FIG. 7, a consumer becomes aware of a product or service that can only be prescribed by a professional and desires to visit an informed local professional who can consult and might prescribe it for the consumer. The consumer obtains information about the product or service of interest 710 and is informed about a service to provide the identity of professionals who have also become aware of the product or service of interest 720. The consumer can query database 426 based upon consumer-selected criteria 730, 740 and matches, if any, are displayed 750. If the matches are insufficient, the selection limitations are displayed and an opportunity to change selection criteria is provided 752, or an opportunity for a delayed report 754. If the consumer revises the criteria, such as scope of geographic area 756, the revised criteria are displayed 730, and database 426 is again queried and results displayed 740. The consumer is informed of the transaction service terms and conditions for a report of informed professionals about a particular product or service 760, and the report is displayed for the consumer 770 in a printable form if the consumer so chooses.

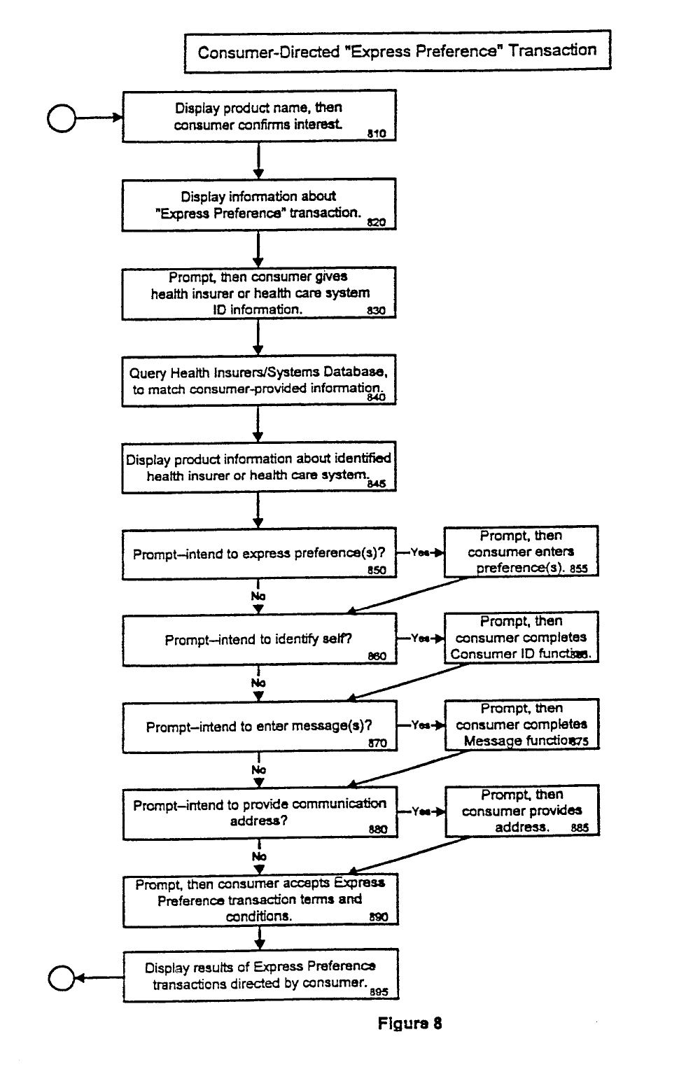

FIG. 8 shows a consumer-directed “express preference” transaction. This type of transaction enables the consumer to express his or her preference to a health care system (HMO, medical insurance provider, etc.) regarding a particular product or service which could be covered or included in the relevant formulary. This transaction also provides information to the consumer, if available, regarding whether a particular product is covered by a particular health care system program at the present time. This transaction process can begin by the consumer expressing an interest in the particular product or service 810. A product-specific website can provide a link to a CDPI website and an option to communicate with or about one's health care system is an option for a consumer transaction. If notifying ones health care system is selected as a transaction 820 after information about it is displayed, the consumer provides information about the health insurer or health care system 830. Once such information is entered, the health insurers/systems database 427 is queried to match the consumer-provided information 840. The information is displayed for customer verification 845 if there is a match with the database 427. The consumer is then prompted to express preferences 850 (and optionally enters them 855), to identify self 860 (and optionally identifies self through ID 865), to enter a message 870 (and enters message to health care system 875), and to provide the consumer's address and contact information 880 (and optionally provides such information 885). The consumer is then provided with transaction terms and conditions 890 and, if accepted, the results of the expressed preference are provided to the consumer 895.

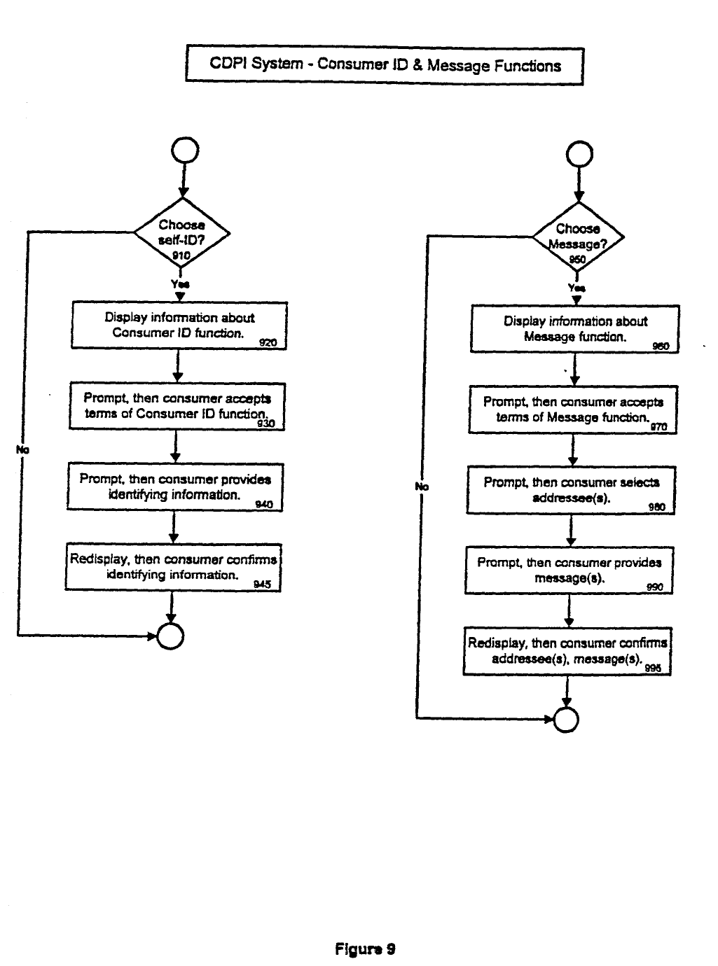

The present inventive process also provides a means for obtaining a positive identification of the consumer for verification purposes and still provides a means for preserving the consumer's confidentiality from professionals, product or service manufacturers or providers, and the health care systems, if the consumer so chooses. In FIG. 9, a consumer chooses a self ID 910 and then the consumer optionally can choose to display information about the consumer ID function 920, accept terms of consumer ID function 930, providing consumer identifying information 940, and displaying and confirming, by the consumer, such identifying information 945. Similarly, and further illustrated in the flow chart on the right side of FIG. 9, a consumer can optionally choose a message 950 and then optionally choose to receive information about a message function 960, accept or reject terms of a message function 970, select addresses for sending the message 980 (such as health insurance carriers, HMO, professionals, or even the manufacturers of the product), provide the message 990, and then review and confirm both the addresses and the text of the message to be sent 995.

Similarly, the consumer can choose whether or not the consumer wishes to receive messages in reply to those sent in the optional process described in FIG. 9. Again, such messages can be sent with or without identifying characteristics of the consumer, at the choice of the consumer. If a consumer chooses to receive a message 1010, information about the message receive function is displayed 1020, the consumer then accepts the terms of the receive function 1030, and if so accepted the consumer is prompted to receive message categories 1040, the consumer provides (or directs creation of) addresses 1050, and the consumer confirms instructions and addresses of senders of messages to be received 1055.

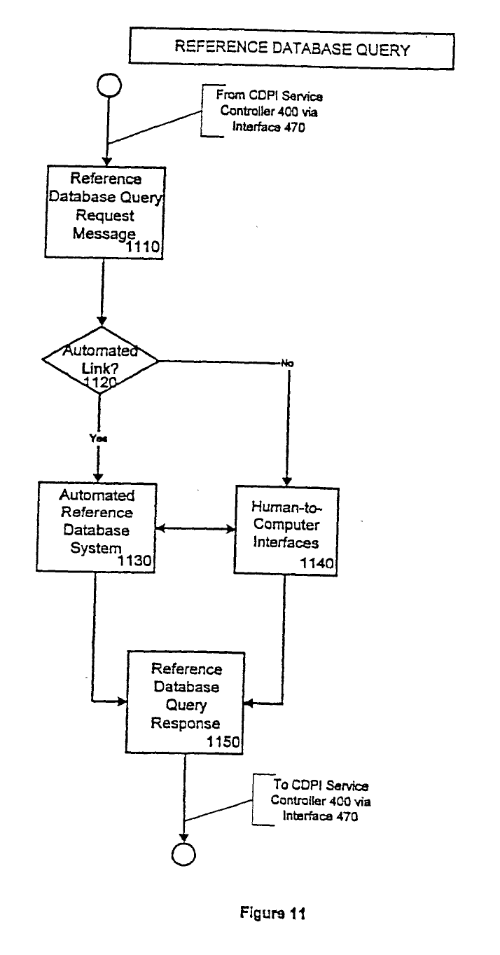

In each of the foregoing transactions illustrated in FIGS. 5-9, a database is queried, selected from the group of databases 421-428 shown in FIG. 4. The process for reference database checking, depending upon the specific transaction selected, is shown in FIG. 11. Specifically, a reference database query request message 1110 is automatically linked to a central server 1120 and then shunted to either a automated reference database 1130 and the proper specific database of the selected transaction, or is sent to a person in the CDPI system for direct query to the relevant database 1140. The response is provided 1150 and returns to the appropriate consumer interface, such as through an Internet website or even a telephone connection.

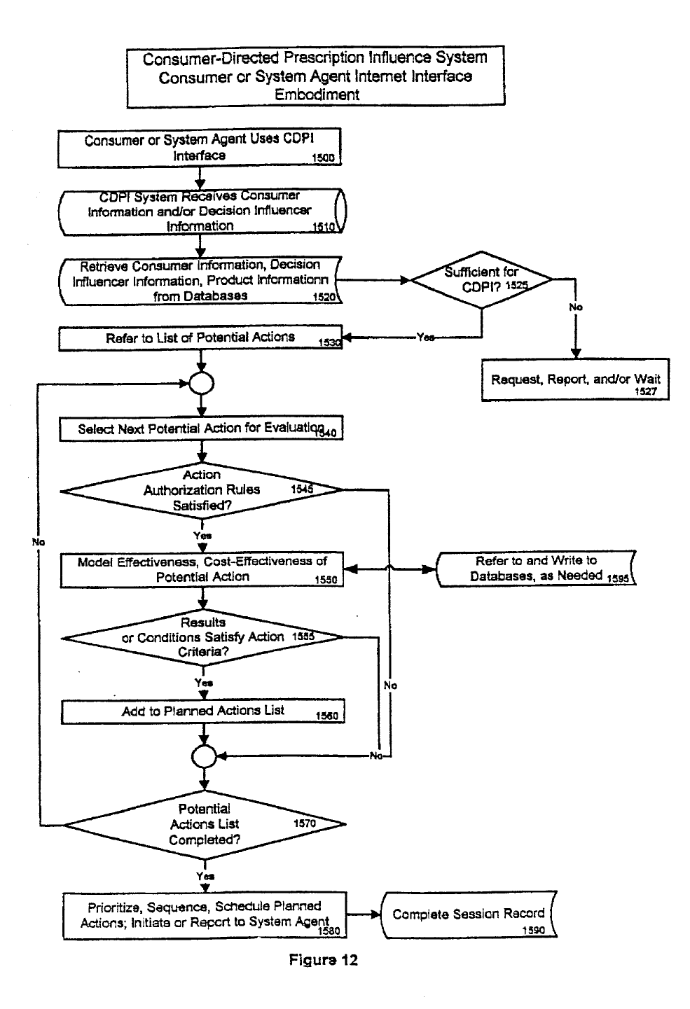

FIGS. 12-15 illustrate additional embodiments of the invention. For facilitating understanding of the invention, the following additional definitions are provided.

Consumer information can include information regarding the characteristics of one consumer or a group or groups of consumers, including for example identity (e.g., name, identifying number), contact information (e.g., postal address, e-mail address, telephone number, preferred communication method), health conditions (e.g., diagnosis, risk factor), product interest, relationships with decision influencers, behaviors (e.g., interactions with CDPI system or other parties), decisions (e.g., selection criteria for doctors, opting in to follow-up relationship with CDPI system, directing particular CDPI transactions), or indications of interest in health care products.

Decision influencer information can include information regarding the characteristics of one decision influencer or a group of decision influencers, including, for example, identity, contact information, specialized activity, licensure, authority, rules defining relationships with consumers (e.g., insurance participation of a doctor, geographic area of a legislator's representation or a regulator's authority), history of CDPI system or other targeting for marketing activities, history of participation in and response to product marketing activities, participation in CDPI system programs (e.g., Find a Doctor, or clinical research trials, or opting in for ongoing CDPI system services).

Target includes one or more decision influencers selected by a consumer or by the CDPI system on behalf of a consumer or on behalf of a product marketer for purposes of taking action to influence the decision influencers' knowledge about, consideration of, advice regarding, and decisions regarding health care products for which a consumer has product interest. Target also can mean one or more consumers with known reason for product interest, and with known reason for relationship with one or more decision influencers. In this context, the consumer or consumers are selected by the CDPI system on behalf of the one or more decision influencers or on behalf of a product marketer for purposes of taking action to facilitate the consumers' interaction with the one or more decision influencers through activities related to understanding, considering, prescribing, obtaining, and/or using one or more identified health care products.

Product interest can include an indication of consumer interest in a health care product, whether the result of overt and explicit declaration of interest (e.g., stating interest in a direct interaction with a system-consumer interface) or the result of a deduction of implied interest (e.g., based on prior or current indication of interest in similarly used products, or based on consumer-declared diagnosis or a CDPI system determination of likely diagnosis).

Action includes any activity or group or sequence of activities initiated by the CDPI system and/or the system agent in response to consumer or decision influencer request for service, or intended to influence a decision influencer or a consumer with respect to a health care product (including, e.g., informational messages sent by any means, invitations to educational/marketing events, provision of product samples, visits by sales representatives, services provided to facilitate consideration or use of a health care product, invitation to participate in or refer patients to a clinical research program), or intended to elicit return of marketing research or outcome/effectiveness information.

Product information can encompass information related to one or more health care products, including, for example, information about disease states for which the product may be useful, basic and clinical trials research results, regulatory stipulations (e.g., product labeling, special marketing or use restrictions), potential actions that may be applicable to that product, status of CDPI system sponsorship by the product manufacturer, product marketing materials and programs made available by the manufacturer or product marketers, disease and product information from other sources, marketing rules established by product marketers (e.g., obligatory actions, structure and parameters of effectiveness and cost-effectiveness models, action threshholds, prioritization and sequencing rules), marketing action resource availability information (e.g., product sample stock, number of attendees open for an educational meeting), identity and contact information for marketing agents (e.g., sales representatives), marketing priority lists of professionals provided by the product marketer.

The embodiments of the invention shown in FIGS. 12-15 will now be discussed. In seeking the best health care for themselves and others, consumers look to health care professionals for assistance. They are often obliged to do so, as access to health care products may be restricted by prescription status, formulary structures of health care systems, insurance coverage contingent on the professional's approval or involvement in securing authorization, etc. And consumers often do so voluntarily, as they value professionals' advice in the decision-making process, even for use of products not subject to access restrictions, such as over-the-counter products.

In addition to health care professionals, other decision influencers are often involved in determining the conditions of consumers' access to health care products. Characteristics of a consumer (e.g., age, gender, health conditions, insurance coverage, health care system enrollments, place of residence, place of employment, employer, etc.) and characteristics of decision influencers (e.g., statutory or contractual or fiduciary/caregiving or personal relationship to consumers, responsibilities, legal or administrative authorities, prescription privileges, characteristics in common with a consumer) can indicate the certainty or likelihood that a particular decision influencer affects a particular consumer's access to health care products. For example, a consumer's personal doctor is certain to affect decision-making and access to health care products. The consumer's personal counselor, though lacking prescription authority, may have a substantial decision influencer relationship with the consumer. The professionals on a pharmacy & therapeutics committee of the consumer's health care system have a strong likelihood of affecting decision-making and access. The insurance commissioner in the consumer's state of residence also has a decision influencer relationship with the consumer. Because collegial influence of professionals' diagnosis and treatment methods is well known and substantial, the colleagues of the consumer's doctor, in the same specialty and geographic area, or perhaps in the same clinic, also have a decision influencer relationship with the consumer. Other consumers with similar characteristics (diagnosis, insurance type, clinic attended) may potentially have some political, financial, informational, or other influence on health care product decisions, and therefore be decision influencers, but they may be unknown to the particular consumer. The less direct the consumer's relationship with the decision influencer, the less likely is that the consumer will be aware of the relationship or aware of how best to exert influence on that decision influencer.

Nevertheless, consumers have a need to influence any or all of the decision influencers that affect or determine their access to health care products. There is a corresponding need in the art to facilitate consumers' ability to influence the decision influencers with which that they have relationships.

Also, consumers' health care needs are often related to chronic conditions. Treatment methods for those conditions change, as new knowledge (clinical trial results) and products become available. Consumers therefore have a continuing need to assure that the decision influencers they have relationships with are informed and influenced in favor of making health care products available and affordable. A consumer may become aware of a particular health care product and choose to overtly indicate interest in it and to overtly direct an action intended to influence a decision influencer, such as illustrated in FIG. 6.

However, the consumer may not become aware of a health care product for which the consumer may have a current or potential need. In such cases, it would best serve the consumer to be informed about the health care product (and then have the opportunity to overtly declare interest and direct action) or to be served by a system that would automatically assess the consumer's likely or implied interest in the health care product and take action to influence the decision influencers related to that consumer. There is a need in the art to provide such a service for consumers.

Similarly, decision influencers have a substantial and continuing interest in knowing and meeting the needs of the consumers with whom they have relationships. Yet they may not be aware of those needs and therefore be unable to meet them. The insurance administrator who is unaware of a new health care product and its importance to a number of product-interested consumers covered by the plan will be unable to anticipate their needs. The continuing education coordinator of a medical clinic will be better able to plan the clinic's professional staff education activities if made aware that a significant number of clinic patients meet the newly revised criteria for prescription of a health care product. A doctor may decide to participate as an investigator in a clinical trial of a health care product if made aware of the product and its applicability to one or more patients in the doctor's practice. A pharmacist may decide to stock and learn about a health care product if made aware of customers' interest in or potential need for it. Thus, there is a need in the art to provide a service that facilitates transfer of information about consumer interest (whether overt or implied) in health care products and that facilitates provision of information and services to support product consideration, decision-making, and use by decision influencers.

Decision influencers may also wish to improve the match between their knowledge and interests and those of consumers who are interested in products. The present invention is suited to that purpose. For example, a doctor with a special interest in irritable bowel syndrome, who has made a particular effort to become expert in using health care products to treat that disorder, can volunteer to be available for consultation with new patients who have used the CDPI system. Or, when a patient in the doctor's clinic shows product interest through the CDPI system, the doctor may want the system to offer that patient an opportunity to attend a consumer education event. A doctor who has accepted a CDPI system invitation to become a clinical trial investigator regarding a health care product may wish to serve consumers who elect to enroll in that trial. A state legislator who has introduced legislation related to availability of health care products may, through the CDPI system, be enabled to offer information or request communications from consumers who are CDPI system users. Such services also achieve product marketing objectives by better preparing consumers and decision influencers to interact regarding issues of health care product availability, appropriateness, and use. Indeed, the availability and particular features of such CDPI system services may be dependent on financial sponsorship provided by a health care product manufacturer or marketer. The basic elements of the CDPI system remain operative, in that the system receives and uses consumer information and decision influencer information to ascertain that the consumer has product interest and that there is an existing or potential relationship between the consumer and the decision influencer, to decide whether taking action is appropriate, and, if so, to take action related to an identified health care product. There is a need in the art to provide such services.

Consumers who may benefit from the use of nonprescription health care products may still be in relationships with various decision influencers with respect to those products. For example, insurance coverage may be provided for some nonprescription health care products if the insurer has included such coverage in the contract negotiated with the consumer's employer, or if use of the product is reviewed by administrators and actuaries and is found to reduce the overall cost of providing health care to the consumer, or if the treating doctor has written a letter documenting necessity of the consumer's use of the product. Or a nonprescription product for which there is no insurance coverage may become more affordable and more available to the consumer if the treating doctor is convinced of its effectiveness and writes a supporting letter which allows the consumer to qualify for a taxdeduction of the cost of the product. A further example is that a product or service vendor may require a doctor's authorization before allowing the consumer access to the product (e.g., participation in a therapeutic exercise program, or purchase of a nonprescription device that may be dangerous for patients with certain health conditions). Or a consumer may simply need a decision influencer's informed counsel before deciding to proceed with using a particular nonprescription product.

Marketers of health care products in the US expend billions of dollars per year in marketing to consumers, professionals, health care systems, and so forth, to influence consumers and decision influencers. However, there is a need to better coordinate these efforts and make more effective, efficient use of these expenditures. If it is possible to target professional marketing efforts to motivate, inform, and influence a particular professional or group of professionals (instead of a less selected group professionals such as all in an area or specialty) based on the product interest of one or more of their patients, marketing to professionals will be more effective and cost-effective. Before the advent of the present invention, there has been no such feasible system to trigger and facilitate the targeting of product marketing to particular decision influencers, based on the product interests of consumers who have relationships with those decision influencers. There is a need in the art to do so.

In health care product marketing systems, different parties may not be allowed to exchange consumers' personally identified health care information. Yet such parties may share interests in improving the effectiveness of health care product marketing. For example, a clinical laboratory may want to improve consumers' health care and to increase consumers' awareness of the importance of a new laboratory test in determining the appropriateness of beginning or continuing the use of a particular medication. Through implementation of the present invention, the clinical laboratory could agree to provide data to the CDPI system, including consumer diagnosis, laboratory test result (if already done), and doctor identification but not including consumer identification. The CDPI system could then proceed to correlate that information with similar information about other patients of that doctor and of that doctor's clinic, analyze the potential effectiveness and cost-effectiveness of various educational service and marketing activities, make related decisions and initiate actions, including reports to the clinical laboratory. The clinical laboratory could then notify patients of the possible appropriateness of a product in their treatment, of the relevance of the laboratory test to the product decision-making process, and of their doctors' receipt of new information about that product, thereby prompting consumer inquiries to the doctors about both product and laboratory test. Similar coordination can be effected between the CDPI system and other parties that interact with consumers and/or decision influencers, such as pharmacy benefit managers, health care systems, etc. There is a need in the art for consumer and professional services and marketing actions based on shared data and consumers' product interest.

In planning, prioritizing, and carrying out marketing activities, there is a need to create and use cost-effectiveness models and decision-making rules. The present invention uses both predetermined rules (e.g., “a consumer-generated, product-related message to a professional regarding a manufacturer-sponsored product will be sent to the designated professional within 2-10 days before the anticipated next clinic appointment, but not if the message contains profanity or the anticipated appointment is less than 2 days from the time the message was created”) and cost-effectiveness modeling (e.g., based on prior experience with the consumer's diagnosis and test result and the known practice and prescribing patterns of the consumer's primary care doctor, calculate the likely product sales result of initiating a specific marketing activity costing $XX, compare that with likely results of initiating other activities, use a set cost-effectiveness threshhold to decide which if any to initiate, and prioritize and sequence the activities which are to be initiated”) to make decisions about initiating marketing activities.

In the further interest of achieving increased effectiveness (e.g., % increase in product sales) and cost-effectiveness (e.g., marketing cost per $XX of increased sales) of a marketing system, there is a need to measure outcomes of the system's activities and then to modify the system's decision-making methods. The present invention uses such outcome measurements (e.g., direct feedback from consumers about prescriptions, from system agents, and from external data sources such as IMS Health data regarding individual doctor prescribing behavior) to compare real outcomes with predicted outcomes and then to modify model parameters (such as probabilities of outcomes, threshholds for decision-making) and decision rules (e.g., regarding obligatory vs. threshhold-decided actions and inaction) for subsequent use by the system. There is a need in the art for marketing systems which incorporate such outcome measures and corrective actions.

FIG. 12 is a flow diagram illustrating operation of an embodiment of the CDPI system. Cumulative advances in several aspects of technology have enabled the design and operation of the invention, such as advances in networked communications systems, in consumer access to and use of those systems, and in processes of data acquisition and processing. Coincident changes in social attitudes and regulation of health products marketing have resulted in rapidly increasing consumer use of health care (disease and treatment/product) information resources. These changes also have increased consumer self-advocacy in relationship to decision influencers. Taken together, these developments have created the need for the present invention.

As will be understood from the following discussion, the CDPI system is designed to meet significant, identified, and unmet needs in the unique marketplace of health care products. The CDPI system serves the interests of consumers, decision influencers, and health care product manufacturers and marketers. It is strongly suited to facilitating health products marketing.

The CDPI system is primarily driven by receipt, storage, and analysis (using logical processes and rules) of information about consumers. This information about consumers includes indications that the consumers do or do not have product interest. Secondly, the CDPI system is driven by receipt, storage, and analysis of information about decision influencers, indicating that particular decision influencers do or do not have product-relevant relationships with particular consumers or consumer groups. Thirdly, the CDPI system can be driven by product information regarding the health care product of interest to the consumer and/or the product marketer. Such information includes (a) reported experience with the use of that product and other products in the management of one or more diseases, provided to the CDPI system by the product marketer or by other sources, (b) information about which CDPI system services have been designated (by the CDPI system management and/or service sponsor, which would commonly be the product marketer) to be made available through the system to consumers and/or decision influencers with that product interest, (c) what potential marketing actions (with respect to decision influencers and/or consumers) may be evaluated and initiated, (d) what priority levels may have been set for targeting actions to particular decision influencers (e.g., based on product marketer's sales experience and strategies), (e) what system agents are involved with the CDPI system to support services and actions regarding the product, (f) what actions are known to be most likely to be effective under various conditions (which information may be represented in decision-making rules or models), (g) what decision-making rules and modeling algorithms have been established for services and actions related to the product. Fourthly, the CDPI system analyzes information and applies decision-making logic to determine which actions (if any) will be taken, in what sequence, and on what schedule. Fifthly, the CDPI system initiates actions that can be taken without the involvement of system agents and provides reports to enable system agents to initiate other actions. Sixthly, the CDPI system receives, stores, and analyzes information regarding action outcomes to allow for improved understanding, modeling, and decision-making regarding product-related actions, which is intended to result in improvement of the system's functioning and in future action outcomes.

FIG. 12 illustrates an embodiment of the CDPI system that includes a consumer or system agent Internet interface in accordance with the invention. In the embodiment of FIG. 12, product-related service is provided to consumers, decision influencers, and health care product manufacturers and marketers. Each step in the flow diagram of FIG. 12 now will be discussed.

In step 1500, a consumer or system agent uses a device to interact with the CDPI system, entering information into it and possibly receiving information from the system. In a preferred embodiment, such device for consumer or system agent use would be Consumer's or System Agent's Interface Device 200, as shown in FIG. 2. Alternatively, the consumer can use an interactive voice response telephonic system, or the consumer can converse directly with a human operator (e.g., a system agent) who, in turn, interacts with the system preferably through Interface Device 200. In another alternative, the consumer can read from and write information on a paper document, which is later transferred to the CDPI system by a system agent. A system agent can use the CDPI interface to provide accumulated information, regarding multiple consumers, to the system by providing a batched electronic data communication or a compact disc.

Examples of system agents include individuals working for a company operating the CDPI system (e.g., staffing a booth at a system-sponsored event), for a service-provider (such as a live-operator call center), for a health care product provider or marketer (such as a clinical laboratory, health care system, pharmaceutical company, pharmacy benefit management company), for a social services agency, or for a community pharmacy. A volunteer conducting screening (questionnaires, tests) at a health fair could be a system agent. System agents need not have a formal or contractual agreement with operators of the CDPI system in order to function as a system agent for purposes of this embodiment of the invention. System agents can also be companies or organizations (such as a pharmacy benefit management company, a health insurance company, or a consumer advocacy group) that have a contractual relationship with and provide consumer information to the CDPI system. A system agent, such as a pharmacy, may be prevented by regulation, agreement, or otherwise from providing personal identifying information about consumers, but they may transfer sufficient information to enable the CDPI system both to determine consumer product interest and product-related relationship to decision influencers and to initiate appropriate actions and/or report information back to the system agent so that the agent can initiate appropriate actions (such as informing the consumer that a particular clinical trials organization will call to make an appointment, or that the consumer's doctor has participated in a product-related educational program).

In step 1510, the CDPI system in fact receives either consumer information or decision influencer information. In addition to the general examples mentioned in the definition of consumer information, above, other specific examples include: concurrent health conditions, occupation or avocation, name of personal doctor and clinic, name of physical therapist, email addresses of friends to whom the consumer would like information sent, consumer's recall of most recent cholesterol level, family history of asthma, major medical center most trusted by the consumer for second opinions, consumer's list of current medications, list of medicines previously not tolerated, length of time since diagnosed with diabetes, and choice of incentive to be provided by CDPI system in exchange for the consumer's participation in a marketing research program. In addition to the general examples mentioned in the definition of decision influencer information, above, other specific examples include: a list of diagnoses for which a specialist will accept new referrals, a nurse practitioner's schedule of appointment availability, colleagues most highly regarded by a particular doctor as sources of clinical advice, list of employers whose employees are covered by a health insurer's benefits, zip codes in a legislator's district, list of members of an HMO's formulary committee, identities of the gastroenterologists most respected by managing pharmacists of a major pharmacy chain, and list of doctors who attended a recent symposium sponsored by marketers of a competing health care product. The information received by the CDPI system in step 1510 allows the CDPI system to determine a consumer's product interest to an acceptable degree of likelihood, to determine the consumer's product-relevant relationship with a decision influencer to an acceptable degree of likelihood, and to proceed to the step of appropriately initiating action. For example, the action of delivering product-related information to a doctor in a defined time frame in advance of a consumer's anticipated appointment with that doctor requires that the CDPI system receive the date of the appointment, confirm that there is an anticipated appointment, and confirm the specific identity and contact information (e.g., postal or email address) of that doctor.

In step 1520, the CDPI system retrieves consumer information, decision influencer information, and product information from the relevant databases. The CDPI system relies on access to accumulated data stored in its databases (such as those in data storage device(s) 420 consumers database 424, sessions database 422, transactions database 423, decision influencers database 425, participating decision influencers database 426, health insurers/systems database 427-or in accessible external database sources). The CDPI system retrieves data for review and current use when triggered to do so by (i) receipt of new consumer information or new decision influencer Information, as shown in step 1510, (ii) by receipt of new product information, or (ii) by a system instruction caused by reaching a scheduled review date. For example, the CDPI system may have stored consumer information and decision influencer information indicating that four consumer members of a health plan have a particular diagnosis and a related product interest, but the CDPI system may not have taken action because of a product-related decision rule that requires five or more consumers to meet criteria before a report would be sent to the health plan's management and formulary committee members. The current addition of a fifth consumer with those characteristics would trigger retrieval of the stored information, recognition that the decision threshhold has been reached, and initiation of appropriate action. Similarly, a current change in product information (new research showing significant advantage, new marketing decision rule, new clinical trial openings) can trigger review of consumer information of product-interested consumers, review of related decision influencer information, and result in a CDPI system decision to take action. Alternatively, the system may accumulate multiple consumers' consumer information and only perform cross-referenced analysis (e.g., to detect clustering of product-interested consumers in relationships with decision influencers) at fixed time intervals.

In step 1525, the CDPI system analyzes received and retrieved data to determine whether there is sufficient indication of product interest on the part of one or more consumers, and whether there is sufficient indication of product-related relationship between consumers and identifiable decision influencers, to justify further analysis of the appropriateness of taking action. If so, the system proceeds to step 1530. If not, step 1527 occurs. For example, a consumer interaction with the CDPI system may have provided information indicating that the consumer has a diagnosis of diabetes and is interested in glucose meters, and may have provided a means for future follow-up (e.g., log-in password for return visit to website, or opt-in permission and e-mail address for e-mail newsletters). The consumer interaction, however, may not have given any information that will allow the system to identify definite or sufficiently likely identities of the consumer's decision influencers. In that case, the answer in step 1525 is No, and step 1527 will occur. Alternatively, if the consumer has given a city of residence and indicates that he/she sees an endocrinology specialist located in that city, that information may permit the CDPI system to conclude that the consumer's specialist is one of the only two endocrinologists in that city. According to the decision rules of the CDPI system, an absolute certainty of consumer relationship to a decision influencer may not be required, and a reasonable likelihood may be sufficient information to continue to step 1530. For example, in the case of a highly priced product for treatment of a rare kidney disorder, the product marketer may have provided a decision rule that authorizes targeting several (e.g., up to six) nephrologists for action, to increase the likelihood that the product-interested consumer will encounter a product-informed doctor at the next clinic visit. Information that allows narrower targeting (e.g., sending sales representatives to call on all the nephrologists in the consumer's specialty clinic, instead of all nephrologists in the county) may establish a sufficient likelihood, even if that likelihood is much less than certainty, of product-related relationship with a decision influencer to trigger marketing action. Similarly, in the absence of overt and explicit indication of the consumer's product interest, the system may determine that a consumer has sufficient likelihood of product interest to proceed with targeting the consumer's identified doctor for action. For example, the consumer may visit a multiple sclerosis information website, view multiple pages of information about relapsing-remitting MS, spending more than 15 minutes in the site, request that selected information be sent to an identified primary care doctor, but not overtly state an interest in the products used to treat that condition. Despite uncertainties about diagnosis, product interest, and reliance on the identified doctor for counsel about treatment (i.e., whether the doctor is truly a product-related decision influencer for this consumer), the CDPI system's decision rules may categorize that consumer as sufficiently likely to have an MS diagnosis and product interest and a product-related decision influencer relationship with the doctor, and the system may proceed to evaluate the appropriateness of taking product-related marketing action targeted to the identified doctor. Thus, the CDPI system may proceed to evaluate and decide on targeted actions on the basis of consumers' implied (instead of explicit) product interest and implied product-related relationships with decision influencers, and the system may also proceed to take action based on a consumer's implied (instead of overt) direction via the system to take action relative to a decision influencer.

Further, in step 1525, the system may consider past consumer behavior in making current decisions regarding likelihood and implied direction. Previously received consumer information data, such as a diagnosis of diabetes, repeated visits to a diabetes information source, identification of a doctor, or a previous report of residential zip code, may be used to estimate probable effectiveness and appropriateness (per system rules) of a potential action.

In step 1527, the CDPI system may generate a request for more information (e.g., online display to consumer to motivate and prompt provision of more information, or request of system agent clinical laboratory to provide physician's name missing in batch data report), and/or may generate a report (e.g., to system agent regarding a pattern of data insufficiency from one business location), and/or may enter a “wait” mode, taking no further action.

In step 1530, the CDPI system retrieves from a product information database (such as manufacturers/products database 421) a set of potential actions which can be taken with respect to a particular product or group of products. For example, in the case of a cardiovascular medication product which is useful for prevention of heart attack in patients who are being treated for diabetes and/or hypertension, the potential actions may have been determined to include (i) sending a message informing a clinic's primary care doctors that a particular number of the clinic's patients with diabetes have recently indicated interest in the product, (ii) enclosing information about research and the product, (iii) providing prescription-starter vouchers, (iv) inviting such primary care doctors to an educational meeting if they have not been accessible to sales representatives, and (v) notifying consumers that their doctors have been provided with product information. The list of potential actions would be very different for a surgically implantable device- (i) a surgeon might be offered extensive training, (ii) the clinic nurse offered training in postoperative management, and (iii) the surgeon then offered the opportunity to be included in a consumer-accessible list of productexperienced specialists.

In step 1540, the CDPI system proceeds to the next of the list of potential actions. For example, having completed analysis of whether a personalized letter should be sent to a doctor on behalf of the consumer, the system might next consider whether that doctor should be invited to participate in a continuing education meeting, receive aggregated reports of consumer diagnoses and product interest, participate as a clinical trials investigator, refer to clinical trials, receive services to facilitate use of the product, receive product samples or vouchers, or be invited to refer patients to a service to increase persistency and adherence to treatment with the product. The same list might include potential actions with respect to the consumer's other product-related decision influencers, such as notifying formulary committee members of the numbers of consumers in their health plan who have indicated strong product interest, or inviting colleagues of the consumer's doctor to attend the same education meeting.

In step 1545, the CDPI system refers to decision rules retrieved from product information to decide whether the potential action under consideration needs to be further considered. For example, there may be a rule that excludes gastroenterologists in a specific metropolitan area from invitation to an upcoming education meeting that is intended for primary care doctors. Some actions may be classified as permission-based, so that only overt direction by the consumer is allowed to trigger a targeted action. A product marketer may have imposed the rule that no doctor can be notified of a consumer's product interest unless the consumer has authorized providing personal identification to the doctor. A particular decision influencer may be on a list of those who have requested that no product marketing materials be sent to them without their explicit request. There may be enough such conditions that only a minority of the product-related decision influencers of the consumer will be identified by the system or will be candidates for any of the system's potential actions. For example, an action campaign targeting governmental officials might be rarely implemented. And the consumer's pharmacist, while influential, may not be a candidate for invitation to a presentation on surgical technique.

In step 1550, the CDPI system can apply a method to model (i.e., intelligently estimate) the likely effectiveness and cost-effectiveness of a potential action given the conditions of the case under consideration. A calculation of utility, based on estimated probabilities of success at successive stages in a process, might be used. For example: The product marketer has established a list of doctors to be targeted in a marketing campaign. The decision model may assign a consumer success probability of 0.9 to a consumer whose interactive behavior indicates a high level of skill, education, and motivation, IF that consumer interacts with the targeted doctor. Information received from the consumer only allows an estimated ⅓ likelihood that an identified doctor on the marketer's target list for the campaign is the consumer's doctor, for an identification success probability of 0.33. Marketing experience with that consumer's presumed doctor sets an activity acceptance probability of 0.4, and there is a doctor adoption probability of 0.5 for the likelihood that the doctor, if informed about the product through the potential action, will adopt use of the product in the next 6 months. The single prescription success probability calculated for this consumer-doctor-action combination would be 0.9×0.33×0.4×0.5=0.06, or 6%. For another consumer-doctor-action combination, the probabilities may be 0.6, 1.0, 0.7, and 0.7 respectively, for a single prescription success probability of 0.29, or 29%. Further modeling of effectiveness, however, takes into account the impact of the overall prescription behaviors of these doctors. If data (e.g., from IMS Health) show that the first doctor may indicate that the doctor is a high prescriber in the product category, writing prescriptions for 8 times as many of this product category as does the second doctor, and if a major goal of marketing is to influence not only the doctor's prescription of the product to the consumer with product interest but also to other consumers, then the adjusted relative value of taking action targeting the first doctor would be 8×0.6=0.48, compared with 1×0.29=0.29 for the second doctor. Other modeling techniques can be contemplated, such as Monte Carlo modeling. Availability of data will be an important factor in permitting or limiting the usefulness of such methods. In any case, the CDPI system will enable use of decision processes, including models, in deciding and prioritizing actions.

Step 1595, which entails referring to and writing to databases, as needed, might be indicated for all steps in the process depicted by FIG. 12. However, it is shown in conjunction with step 1550 to emphasize the potentially data-intensive nature of modeling and decisionmaking processes.

In step 1555, the CDPI system uses information about the conditions of the case under evaluation and/or the results of modeling (step 1550), combined with criteria for taking action, to make decisions about actions. Regarding use of the conditions of the case, for example, the system might employ a rule that overrides modeling and obligates action any time a headache specialist on a marketer's target list is possibly matched with a product-interested patient, regardless of the probabilities involved. Or, a system record that a doctor has received two product-related mailings in the current month might preclude or modify plans for a third mailing. Regarding use of modeling results, in the example described for step 1550, if the system's adjusted relative value decision-making threshhold for taking action is 0.35, then the first doctor will be targeted for action and the second will not.

In step 1560, the CDPI system simply adds an action for which action criteria are satisfied to the list of planned actions. There may be more than one action decided in relation to the case under evaluation, and the actions may be directed to a variety of targets.

In step 1570, the CDPI system checks to see whether all potential actions of the list of potential actions (generated in step 1530) have been evaluated. If no, step 1540 ensues. If yes, then the CDPI system proceeds to step 1580.

In step 1580, the CDPI system proceeds, with automated or nonautomated methods, to plan the specific implementation of targeted actions. This step involves reference to other data, as some actions call for coordination. For example, inviting doctors to an educational activity involves reference to data about invitations already sent, acceptances received, venue capacity, invitation lead time, etc. In actions targeting health plan administrators, a report of aggregated data about consumer interest may be considered more effective than single-consumer interest, so action may be deferred, up to a determined time limit, in anticipation that more consumer interest may be aggregated.

In addition, it may be known that it is more effective for a representative to visit a doctor and provide product samples shortly after the doctor has received a message of consumer interest, rather than before; such considerations may determine sequencing of planned actions. In the context of step 1580, system agents may be, for example, individuals, companies, or organizations, including a manufacturer's sales representatives, a professional education event coordinating company, a mail fulfillment house, or a professionals-only website sponsor. In the case of an action being targeted to a consumer (i.e., invitation to participate in a clinical trial, or to attend an education event where the decision influencer will be a speaker, or to visit a doctor's practice website), based on the consumer's product interest and product-related relationship with a decision influencer that has chosen to participate in consumer-targeting CDPI system activities, the system agent could in fact be the decision influencer.

In step 1590, the CDPI system completes a record of the session that has occurred. Possible sessions include an interactive session or data-receiving session with the consumer or system agent, or an automatically triggered data review and evaluation session.

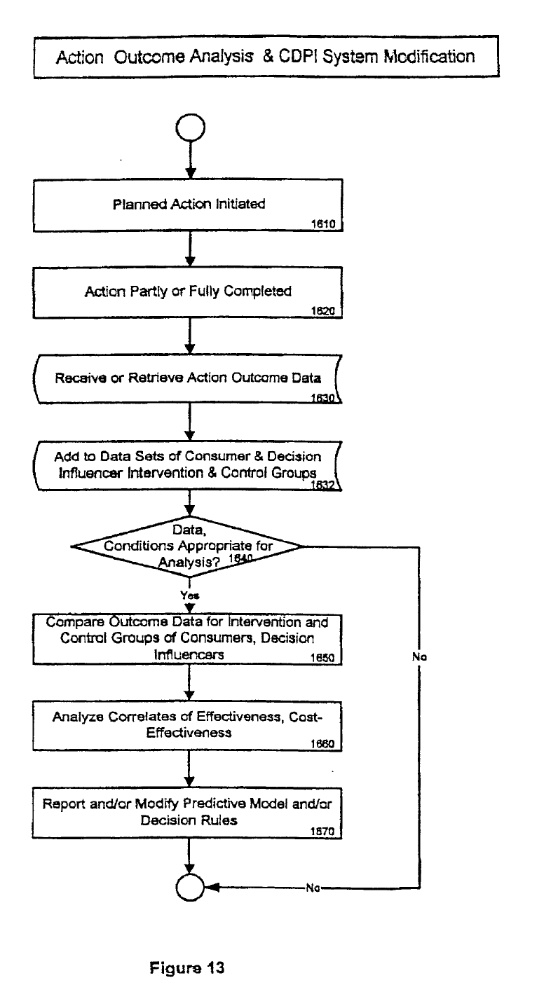

FIG. 13 illustrates a flow diagram for an Action Outcome Analysis & CDPI System Modification process. According to FIG. 13, the CDPI system initiates actions, and data related to the results or outcomes of those actions subsequently become available for analysis. Where the system's decision-making processes are based on experience-based rules and/or modeling of likely outcomes, actual measured outcomes can be compared with the outcome estimates predicted by modeling. This provides an opportunity to identify deficiencies in the decision rule structure or modeling process, and then to modify the decision rules and model parameters for better future performance. As with other features of the CDPI system, these functions are designed to support the system's use of data regarding consumer product interest and consumers' product-related relationships with decision influencers. Such use enables the system to provide product-related services to both consumers and decision influencers and to accomplish health care product marketing by tightly coordinating consumer and non-consumer marketing efforts and measuring marketing outcomes with a high degree of specificity and accuracy. Such measurement is enabled by the CDPI system's targeting of particular decision influencers (based on product-related relationships with consumers who have known product interest) for actions, which in turn enables the measurement and analysis of outcomes (such as doctors' prescribing behaviors) related to those decision influencers.

In step 1610 of FIG. 13, planned action is initiated. The CDPI system or a system agent initiates a planned, targeted action. The variety of system agents, of targeting, and of potential actions has been discussed above.

In step 1620, the planned action has been initiated and has proceeded to some degree of completion. For example, an invitation to an educational event may have been offered and accepted, but the event has not occurred. Or a targeted sequence of actions including mailing, representative visit, sampling, and invitation to educational events may have reached the representative visit and sampling stage. Similar action sequences directed to different targets may have proceeded to completion or to different stages.

In step 1630, Receive or Retrieve Action Outcome Data, the system receives new data input (e.g., a report regarding response to an event invitation by gastroenterologists who received patient-directed mailings about a particular product) and/or retrieves previously stored data regarding action outcomes.

In step 1632, the CDPI system transfers pertinent outcome data (e.g., prescriptions written by doctor in three months subsequent to action, or percentage shift in doctor's prescription of marketed product versus competitive products, or information that a decision influencer accepted an event invitation AND attended, or that a consumer communicated to CDPI system whether or not prescription was received) to system databases within data storage devices 420, for subsequent reference regarding the characteristics of targeted decision influencers and their relationships to consumers, and the characteristics of those consumers. Further, the system specifically saves data of measurable results of actions taken and tracks those results for both intervention and control groups. For example, a group of 200 “intervention” doctors who have been targeted with a consumer-directed product information mailing action may be compared with a control group of 400 doctors matched to the intervention group for demographic and marketing exposure characteristics, the intention being to compare measurable outcomes between the two groups after some period of time. Similar outcome measures could be made for groups of consumers, for example: what percentage of consumers who have explicitly directed a CDPI action subsequently remain on their new prescriptions, as compared with consumers with new prescriptions who have not explicitly directed a CDPI action; or what percentages of consumers with various indicators of product interest (e.g., explicit statement, overt direction of action, requests for downloads of related web pages, related diagnosis, suitable laboratory test results, established use of related products) show various product-related outcomes (e.g., report of discussion with doctor, of request for prescription, of received prescription, of persistence and adherence) after the CDPI system initiates various actions targeted to those consumers' decision influencers. Results of such outcome analyses can enable the CDPI system to adjust its criteria for estimating a consumer's likelihood of marketing-effective product interest when explicit statements of interest are lacking. Similarly, results of outcome analyses can enable the CDPI system to adjust its criteria for estimating the likelihood that product-related relationships exist between consumers and decision influencers, and criteria for estimating the relative strengths of different categories of decision influencers.

In step 1640, the system tests whether criteria are satisfied for assessing outcomes. For example, if there is a comparison study of intervention and control groups as described in step 1632, there may be a requirement that individual doctors' outcomes be measured at a particular time interval after each doctor's experience of the targeted action, and that similar outcomes be measured at similar times for doctors in the control group. When, for example, data has been received regarding a sufficient number of each group, the analysis of data may proceed. If not, then the subsequent analysis and reporting steps are, for the time being, not taken.

In step 1650, the system provides for examination of comparative data.

In step 1660, the system uses analytic techniques to gain an understanding of the consumer and decision influencer characteristics (e.g., including their behaviors, system actions taken, timing, sequencing, target groupings, and interfaces used) most likely to influence measurable outcomes. As with other steps in the process depicted by FIG. 13, this need not be entirely automated and may involve human interfaces and judgments.

In step 1670, the CDPI system provides results of data accrual and analysis. This allows decision rules and predictive model parameters to be changed in ways that will provide better predictive results with subsequent use of the rules and models.

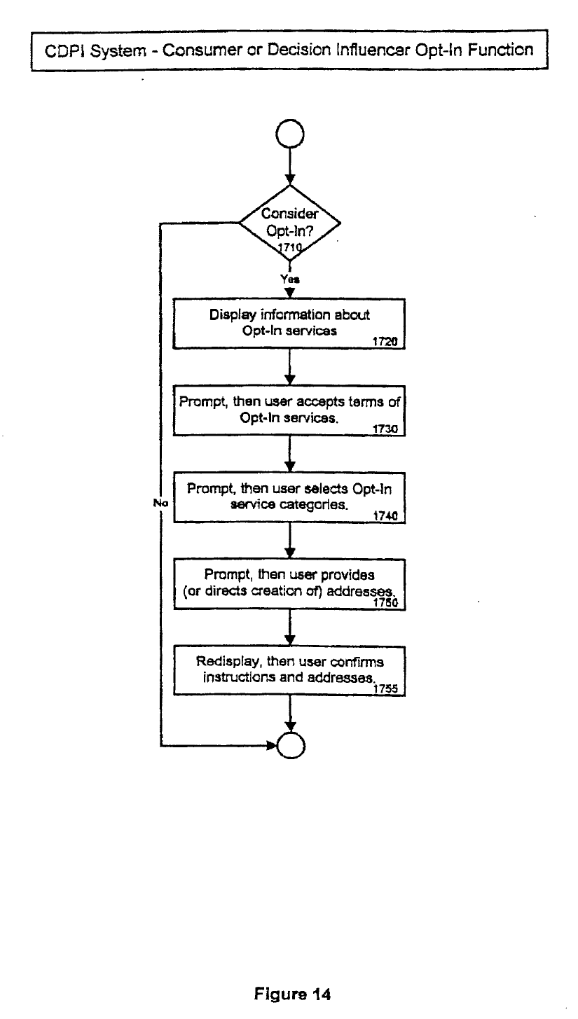

Turning now to FIG. 14, the CDPI system provides opportunities for consumers and decision influencers to voluntarily choose to continue to interact with the system in various ways. If the opt-in function is accepted by the system user, here, either consumer or decision influencer, the function establishes a permission-based, continuing relationship between the system and the system user. This function has particular application in a CDPI system, where the consumer may depend on the system to notify the consumer regarding the availability and applicability of new health care products to the consumer's health care. For example, if a consumer with type 2 diabetes has given permission for the system to maintain contact (e.g., by periodic or as-needed e-mail messages, or by communication through a system agent), then information about the availability of new research results, clinical trial opportunities, and new products can be expeditiously communicated to the consumer. Similar informational services can be offered to decision influencers, including reports of consumer product interest and expressed consumer preferences. A consumer or decision influencer may also overtly or implicitly (e.g., under the terms of a contract with a health system, or pharmacy benefit manager, even if the consumer is unaware of the existence of the CDPI system) choose to allow CDPI system contact through a system agent. For health care product marketing purposes, it is highly beneficial to maintain a continuing relationship with consumers who have provided information about their interest in products and about decision influencers who have product related relationships with those consumers. Such ongoing contact also reinforces product persistence and adherence and provides opportunities for marketing research (often with service or other compensation offered in exchange for information). Again, a central and novel feature of the CDPI system is that it organizes relationships, decisions, processes, services, and actions around data regarding the consumer's interest in health care products and the consumer's product-related relationships with decision influencers. The Opt-in CDPI system services maintain and reinforce that emphasis.

In step 1710, the CDPI system prompts the user (consumer or decision influencer), through direct interface or otherwise, to consider giving permission for ongoing contact with the CDPI system. In step 1720, the system displays information to the user regarding opt-in services—features, advantages, requirements, etc. In step 1730, the user accepts the terms of Opt-in services. In step 1740, the user selects Opt-in service categories. The system will provide services that maintain the flow of product-relevant information to and from the user and will offer opportunities for users to increase their product-related interactions (such as consultation regarding new product interest, availability, appropriateness for use, clinical trials opportunities, coupon provision, use of services to support prescription persistence and adherence). In step 1750, the system gives the user methods for providing contact address information (e.g., e-mail address, telephone number, postal mail address) and possibly for creating contact addresses (e.g., CDPI system-hosted email service). In step 1755, the system presents options, choices made, instructions given, and contact information provided by the user, and prompts the user for confirmation (or correction, then confirmation).

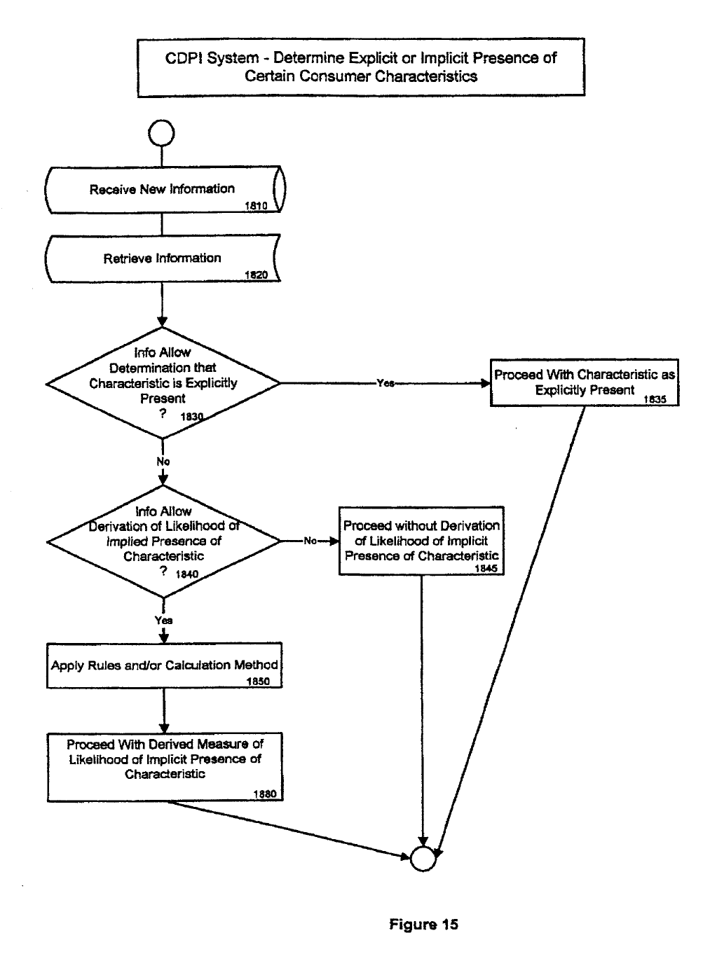

Referring now to FIG. 15, a process of determining the presence, either explicit or implicit, of certain consumer characteristics using relevant information and logical processes is depicted. If implicit, the process determines the degree of likelihood that the characteristic exists. Specifically, the CDPI system uses this process with respect to certain consumer characteristics which are important to the system's operation, namely (a) product interest, (b) product-related relationship with a decision influencer, and (c) consumer intent to direct that a particular action or any action be taken in order to influence a decision influencer. The CDPI system may use the same or similar processes to make other determinations of the existence of consumer or decision influencer characteristics.

In step 1810, the CDPI system can receive new consumer information, decision influencer information, or product information. This information may or may not contain information pertinent to the determination of the existence of the characteristic(s) under consideration. The receipt of the information triggers further steps in this process.

In step 1820, the CDPI system retrieves consumer information, decision influencer information, or product information from databases. Consumer information may include indication of the consumer's explicit “yes” response to a prompt regarding interest in a product, or indication of the consumer's diagnosis, or of the webpages visited by the consumer. It may also include information regarding the consumer's definite (explicitly stated) or possible (e.g., based on location, clinic registration) relationships with various decision influencers. Decision Influencer information may include indications of existing or potential relationships with various consumers (e.g., being one of two endocrinology consultants for a certain health plan, being the regional administrator of a health services agency, being a clinical investigator available to enter new enrollees into a clinical trial, or being a neurotherapeutics formulary committee member for a pharmacy benefit manager). This information is retrieved because, combined with whatever new information may have been received, it is relevant to the determination of existence of the characteristic(s) under consideration.

In step 1830, the system considers whether the available information allows a determination that the characteristic(s) under consideration exists explicitly. For example, if the consumer entered or confirmed an individual personal physician identity in relation to a stated product interest, the presence of that information will allow a determination that the consumer characteristic of product interest is explicitly present. If the characteristic of product-related relationship to the identified personal physician is under consideration in the current iteration of the process depicted, the available information would also determine the explicit existence of that characteristic.

In step 1835, having confirmed a “yes” answer to the question posed in step 1830, the CDPI system proceeds on the basis of the determination that the characteristic explicitly exists. The system may still need to determine the presence and explicit or implicit quality of other characteristics, in which case the process depicted by FIG. 15 is repeated as often as necessary.

In step 1840, the system considers whether the available information allows a determination of the likelihood that a consumer characteristic under consideration exists implicitly. The rules and method imbedded in the system logic will require that certain data fields contain information for the determination to occur. Absence of one or a combination of data fields will result in the determination that one or more likelihood measures cannot be determined.

In step 1845, the CDPI system has determined a “no” answer to the question posed in step 1840, and the system will proceed without a derivation of a likelihood measure for the implied presence of the characteristic under consideration. The system may still need to determine the existence and explicit or implicit quality of other characteristics, in which case the process depicted by FIG. 15 is repeated as often as necessary.

In step 1850, the system uses rule-based and/or calculation methods to derive one or more likelihood measures for the implied presence of the characteristic under consideration. As discussed elsewhere, the rules and algorithms for such calculations are most likely to be product-specific and therefore will be found in the product information database. An example of a simple rule might be that a previous positive determination of the existence of implied product interest will override any more recent non-explicit information. In that case, a consumer whose previous behavior was interpreted as an indication of implied product interest and who has not explicitly denied product interest will continue to be considered to have implied product interest. Another rule might be that a consumer who gives a job-location zip code, but not a home residence zip code, will be considered to have an implied relationship to a state legislator whose district encompasses the consumer's job-location zip code. An algorithmic calculation may be used to derive one or more likelihood measures for implied presence of the certain characteristic. For example, if a product-interested consumer is known to receive specialty pulmonary care in a particular clinic, and there are 5 pulmonologists in that clinic, the consumer may be estimated to have a 20% (⅕) likelihood of a product-related relationship with any individual pulmonologist, but a 100% likelihood of a relationship with some pulmonologist in the group. The 20% likelihood would be applicable to decision algorithms regarding actions targeted to one selected pulmonologist, but the 100% likelihood is applicable to decision processes regarding actions targeted to the group of pulmonologists. The result of an algorithmic calculation might be converted, by application of a threshhold test, to an absolute yes/no indication of implied existence of a characteristic. For example, if a threshhold of 65% calculated likelihood is applied, then a calculated value of 30% likelihood of product interest would be converted to a “no” indication of implied existence of product interest, whereas a calculated value of 70% likelihood would be converted to a “yes” indication. Both rule-based and calculation method approaches may be used, as different likelihood measures may be considered useful for different decision-making purposes.

In step 1880, the system proceeds with further decision processes based on the derived measures of likelihood of implied existence of the characteristic under consideration. The system may still need to determine the existence and explicit or implicit quality of other characteristics, in which case the process depicted by FIG. 15 is repeated as often as necessary.

Methods and apparatus for facilitating marketing of health care products has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. A method employing a computer system for marketing a health care product, the method comprising:
receiving information about characteristics of at least one of a consumer and a decision influencer;
based on the received information, retrieving stored information from a database accessible by the computer system, the stored information containing at least one of consumer information, decision influencer information, and product information;
analyzing the received information and the stored information to determine presence of a sufficient indication of at least one of (i) consumer interest in the health care product and (ii) product-related relationships between the consumer and decision influencers identifiable from the stored decision influencer information;
if sufficient indication is present, retrieving a list of potential actions related to the health care product from a product information database;
evaluating whether to perform each of the potential actions based on at least one of the consumer information, the decision influencer information, the product information, and action-specific criteria; and
performing potential actions that meet action-specific criteria.

2. The method according to claim 1, further comprising, prior to the performing step, prioritizing the potential actions that meet action-specific criteria.

3. The method according to claim 1, further comprising, prior to the performing step, sequencing the potential actions that meet action-specific criteria.

4. The method according to claim 1, further comprising, prior to the performing step, grouping the potential actions that meet action-specific criteria.

5. A computer-implemented method for facilitating marketing of a health care product, the method comprising:
receiving input from at least one of a consumer and a system agent that identifies consumer interest in the health care product and that contains consumer identity information;
based on the input, identifying a decision influencer that has a product-related relationship with the consumer; and
absent explicit instruction from the consumer, communicating information about at least one of the consumer interest, the product-related relationship, and the health care product to the identified decision influencer.

6. The method according to claim 5, wherein the identifying step is accomplished by identifying the decision influencer from a plurality of decision influencers stored in a database.

7. A computer system to facilitate marketing of a health care product, comprising:
an interface device for receiving information about characteristics of at least one of a consumer and a decision influencer; and
a system controller having access to a first data medium that stores data about a plurality of decision influencers and a second data medium that stores data about the health care product, wherein, based on the characteristics information and the stored data, the system controller identifies decision influencers that have a product-related relationship with the consumer and communicates information to the identified decision influencers about at least one of the health care product, consumer interest in the health care product, presence of the product-related relationship with the consumer, and a request by the consumer that the information be communicated.
